(19) United States
(12) Patent Application Publication
(10) Pub. No.: US 2008/0279478 A1
(43) Pub. Date: Nov. 13, 2008

(54) Image processing method and image processing apparatus

(76) Inventors: Mikhail Tsoupko-Sitnikov, Campbell, CA (US); Igor Borovikov, Foster City, CA (US); Shinichi Yamashita, Tokyo (JP); Masuharu Endo, Nagoya (JP)

Correspondence Address: Ralph A. Dowell of DOWELL & DOWELL P.C., 2111 Eisenhower Ave, Suite 406, Alexandria, VA, 22314, US

(21) Appl. No.: 11/798,036

(22) Filed: May 9, 2007

(51) Int. Cl. G06K 9/32

(52) U.S. Cl. 382/298; 375/E07.279

(57) ABSTRACT

An image frame is segmented into a plurality of groups of blocks characterized by movements approximating each other. An image reader receives a source image frame and a destination image frame in image data including consecutive image frames and segments the frames into blocks. A corresponding point information generator computes matching to detect corresponding point information indicating correspondence between the source image frame and the destination image frame and generates a corresponding point information file which describes coordinates of corresponding points in the image frames. An affine parameter calculating unit calculates affine parameters indicating deformation and movement of a block occurring between the source image frame and the destination image frame, on the basis of the corresponding point information. A seed block growth unit examiners a block adjacent to a seed block serving as a starting point for area growth and repeats a determination as to whether the seed block should be combined with the adjacent block so as to segment an image frame into a group of background blocks characterized by movements approximating each other and the other groups of blocks.

### BACKGROUND OF THE INVENTION

1. Field of the Invention

The present invention relates to an image processing method and apparatus which utilizes corresponding point information indicating correspondence between image frames.

2. Description of the Related Art

With a significant development in processors and LSI technologies in recent years, digital image processing of still images and moving images have been applied to extensive areas. Currently, generation, recording, processing, reproduction and transmitting/receiving of images can easily be practiced not only by image processing specialists but also by ordinary individuals. Particularly noteworthy is that development in compression technologies like Joint Photographic Experts Group (JPEG) and Motion Picture Expert Group (MPEG) enables storage and transmission of high-quality image data. Currently, digital still cameras capable of storing still images of 4 million pixels or more is commonplace.

As many of the digital still cameras are equipped with a movie recording function and digital video cameras with a still image recording function, the boundary between the two is becoming fuzzy.

In the technology we proposed in our Japanese patent No. 2927350, a given frame and a subsequent frame are examined so as to determine points where a sum of potential energy and pixel energy is at minimum. Thereby, targets of bijective mapping are determined for vertices in each block. In this way, highly precise matching is possible and the efficiency of compressing moving images is enhanced.

Implementation of bijective mapping presents a problem as described below. That is, if there is a moving object in a screen, the background image is hidden as the object moves. Therefore, some portion of the background may be visible in a given frame and hidden by the object so as to be invisible in a next frame. Conversely, some portion of the background hidden by the object and invisible accordingly may be visible in a next frame as it appears from behind the object. In such a region, pixels observed in a given frame do not find matching pixels in a next frame. For this reason, precise bijective mapping is impossible in a block which includes such pixels, resulting in distortion of the block. Such a distortion affects the efficiency of compressing moving images and may result in inaccurate reproduction of decoded images.

### SUMMARY OF THE INVENTION

In this background, a general purpose of the present invention is to provide a technology for accurately detecting and isolating a region hidden by an object moving between image frames.

An image processing method according to at least one embodiment of the present invention comprises: computing matching so as to detect corresponding point information indicating pixel-by-pixel correspondence between in two image frames in image data comprising consecutive image frames; calculating affine parameters indicating deformation of a block occurring between image frames, on the basis of the corresponding point information; and segmenting an image frame into a plurality of groups of blocks characterized by movements approximating each other, by referring to the affine parameters to combine blocks.

The term “corresponding point information” refers to information indicating correspondence between frames and obtained according to the base technology. Affine parameters are parameters obtained for a block formed of, for example, 2×2 pixels and indicate deformation of the block occurring between a source image frame and a destination image frame. The corresponding point information is used in obtaining the parameters. A motion vector may be calculated on the basis of the corresponding point information or may be calculated by using other technologies such as optical flow estimation.

According to this embodiment, an image frame can be segmented into a plurality of groups of blocks including, for example, the background block or blocks of moving objects. Thus, different matching methods can be used for compression and reproduction of moving images in the respective blocks.

Whether to combine blocks may be determined on the basis of an error between a representative pixel value of a source block and a representative pixel value of a block at a target of transformation using affine parameters.

The method may comprise generating an edge image that represents a boundary between a moving object and a still object in an image frame; determining a seed block that serves as a starting point in combining blocks in an image frame; comparing, in determining whether to combine blocks, a pixel value of an edge image included in the seed block and a pixel value of an edge image included in an adjacent block; and combining the seed block and the adjacent block when a difference in the pixel values is equal to or smaller than a threshold.

Another embodiment of the present invention relates to an image processing apparatus. The apparatus comprises: an image reader which receives a source image frame and a destination image frame in image data comprising consecutive image frames, and segmenting the frames into blocks; a matching processor which computes matching to detect corresponding point information indicating correspondence between the source image frame and the destination image frame, and generating a corresponding point information file which describes coordinates of corresponding points in the image frames; an affine parameter calculating unit which calculates affine parameters indicating deformation and movement of a block occurring between the source image frame and the destination image frame, on the basis of the corresponding point information; a seed block selector which refers to the affine parameters so as to select, from the blocks within the source image frame, a seed block serving as a starting point for area growth; and an expander which repeats a determination as to whether the seed block should be combined with a block adjacent to the seed block so as to segment an image frame into a group of background blocks characterized by movements approximating each other and the other groups of blocks.

According to this embodiment, a seed block in an image frame is defined a starting point and a determination is made block by block as to whether a surrounding block can be combined with the seed block. In this way, an image frame can be segmented with precision into a plurality of groups of blocks including, for example, the background block or blocks for moving objects.

The expander may comprise an expansion determining unit which assigns the same affine parameters as the seed block to the adjacent block, and determines that the seed block and the adjacent block should be combined when a difference between a representative pixel value of the adjacent block at the destination of movement using the affine parameters and a representative pixel value of a corresponding block in the destination image frame is equal to or smaller than a predetermined threshold. The expander may repeat the process of combining the seed block and adjacent blocks until there are no more adjacent blocks that can be combined.

The seed block selector may examine the source image frame blocks subjected to affine transformation using the affine parameters and select, as a seed block, a block characterized by a minimum error between a representative pixel value of the block and a representative pixel value of a corresponding block in the destination image frame, and the expander may combine the adjacent block with the seed block, when a difference between a representative pixel value of a block identified by applying the affine parameters of the seed block to the adjacent block for transformation, and a representative pixel value of a block in the destination image frame which block corresponds to the adjacent block is equal to or smaller than a threshold.

The expander may comprise an edge retrieving unit which generates an edge image by detecting an edge between an object and the background in an image frame, and detects an edge between a moving object and a still object by removing an edge between still objects by multiplying an occlusion area with the edge image, the occlusion area being hidden behind an object moving between image frames or presenting itself from behind the object. The expander may determine whether to combine the seed block with the adjacent block on the basis of comparison between a pixel value of an edge included in the seed block and a pixel value of an edge included in the adjacent block.

Another embodiment of the present invention relates to an image processing method. The method comprises: computing matching between two image frames in image data comprising consecutive image frames so as to generate corresponding point information indicating correspondence between the image frames; calculating a motion vector for each pixel, on the basis of a result of matching; detecting, on the basis of the motion vector, an occlusion area, the occlusion area being an area where an object is hidden in a frame by another object in the same frame, or where an object hides another object in the same frame; and isolating a stationary part from a moving part in an image frame, on the basis of the motion vector and the occlusion area.

For generation of corresponding point information indicating correspondence between image frames, the technology (hereinafter, referred to as “base technology”) proposed in Japanese Patent No. 2927350 commonly owned by the assignee of the present patent application would be used.

Any arbitrary replacement or substitution of the above-described structural components and the steps, expressions replaced or substituted in part or whole between a method and an apparatus as well as addition thereof, and expressions changed to a computer program, recording medium or the like are all effective as and encompassed by the present embodiments.

### BRIEF DESCRIPTION OF THE DRAWINGS

FIG. 1a is an image obtained as a result of the application of an averaging filter to a human facial image.

FIG. 1b is an image obtained as a result of the application of an averaging filter to another human facial image.

FIG. 1c is an image of a human face at p^{(5,0)} obtained in a preferred embodiment in the base technology.

FIG. 1d is another image of a human face at p^{(5,0)} obtained in a preferred embodiment in the base technology.

FIG. 1e is an image of a human face at p^{(5,1)} obtained in a preferred embodiment in the base technology.

FIG. 1f is another image of a human face at p^{(5,1)} obtained in a preferred embodiment in the base technology.

FIG. 1g is an image of a human face at p^{(5,2)} obtained in a preferred embodiment in the base technology.

FIG. 1h is another image of a human face at p^{(5,2)} obtained in a preferred embodiment in the base technology.

FIG. 1i is an image of a human face at p^{(5,3)} obtained in a preferred embodiment in the base technology.

FIG. 1j is another image of a human face at p^{(5,3)} obtained in a preferred embodiment in the base technology.

FIG. 2R shows an original quadrilateral.

FIG. 2A shows an inherited quadrilateral.

FIG. 2B shows an inherited quadrilateral.

FIG. 2C shows an inherited quadrilateral.

FIG. 2D shows an inherited quadrilateral.

FIG. 2E shows an inherited quadrilateral.

FIG. 3 is a diagram showing the relationship between a source image and a destination image and that between the m-th level and the (m−1)th level, using a quadrilateral.

FIG. 4 shows the relationship between a parameter η (represented by x-axis) and energy C_{f} (represented by y-axis).

FIG. 5a is a diagram illustrating determination of whether or not the mapping for a certain point satisfies the bijectivity condition through the outer product computation.

FIG. 5b is a diagram illustrating determination of whether or not the mapping for a certain point satisfies the bijectivity condition through the outer product computation.

FIG. 6 is a flowchart of the entire procedure of a preferred embodiment in the base technology.

FIG. 7 is a flowchart showing the details of the process at S1 in FIG. 6.

FIG. 8 is a flowchart showing the details of the process at S10 in FIG. 7.

FIG. 9 is a diagram showing correspondence between partial images of the m-th and (m−1)th levels of resolution.

FIG. 10 is a diagram showing source images generated in the embodiment in the base technology.

FIG. 11 is a flowchart of a preparation procedure for S2 in FIG. 6.

FIG. 12 is a flowchart showing the details of the process at S2 in FIG. 6.

FIG. 13 is a diagram showing the way a submapping is determined at the 0-th level.

FIG. 14 is a diagram showing the way a submapping is determined at the first level.

FIG. 15 is a flowchart showing the details of the process at S21 in FIG. 6.

FIG. 16 is a graph showing the behavior of energy C_{f}^{(m,s)} corresponding to f^{(m,s)} (λ=iΔλ) which has been obtained for a certain f^{(m,s)} while changing λ.

FIG. 17 is a diagram showing the behavior of energy C_{f}⁽ⁿ⁾ corresponding to f⁽ⁿ⁾ (η=iΔη) (i=0, 1, . . . ) which has been obtained while changing η.

FIG. 18 is a flowchart showing the procedure by which the submapping is obtained at the m-th level in the improved base technology.

FIG. 19 shows the structure of an image processing apparatus according to an embodiment.

FIG. 20 is a flowchart showing a schematic operation according to the embodiment.

FIG. 21 is a flowchart showing the detail of step S106 for generating a seed segment.

FIG. 22 shows how an image frame is divided into a plurality of equally-shaped blocks.

FIG. 23 shows how adjacent blocks are assigned the same label as a seed block.

FIG. 24 is a flowchart showing the detail of step S108 for expanding a seed segment area.

FIG. 25 is a flowchart showing the detail of step S144 for determining a condition warranting combination.

FIG. 26 is a flowchart showing a method of calculating a corrected edge degree used in the determination in S156.

FIGS. 27A and 27B show a relation between a mask and a blurred mask.

FIG. 28 is a flowchart showing a process of merging seed segments.

FIG. 29 is a flowchart showing a process of merging seed segments.

FIG. 30 is a flowchart showing the detail of step S102 for improving a motion vector.

FIG. 31 is a flowchart showing the detail of step S206 for improving a motion vector.

FIG. 32 schematically shows a layer.

FIG. 33 is a flowchart showing the detail of step S104 for generating a mask.

FIGS. 34A and 34B show a difference between a covered area and an uncovered area.

FIG. 35 shows an example of a mask.

### DETAILED DESCRIPTION OF THE INVENTION

The invention will now be described by reference to the preferred embodiments. This does not intend to limit the scope of the present invention, but to exemplify the invention.

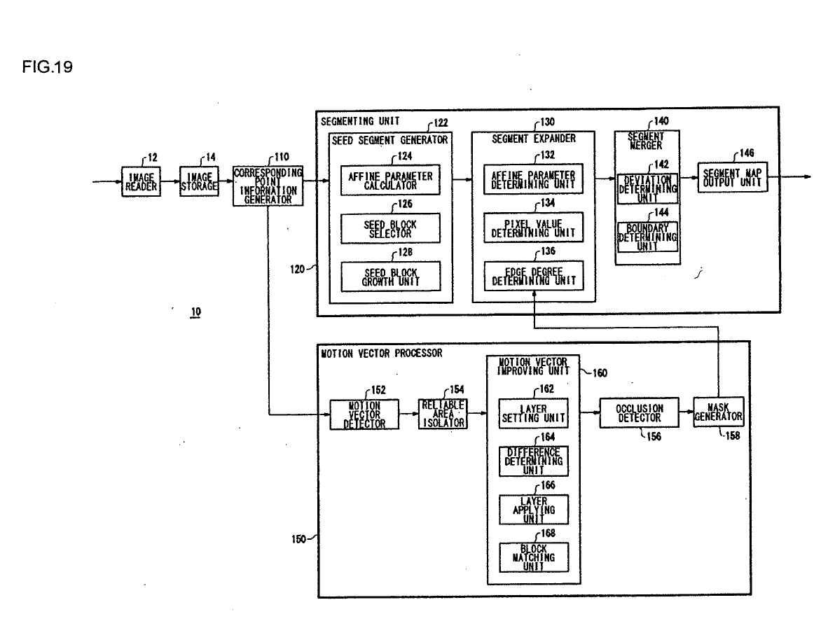

At first, the multiresolutional critical point filter technology and the image matching processing using the technology, both of which will be utilized in the preferred embodiments, will be described in detail as “Base Technology”. These techniques are patented under Japanese Patent No. 2927350 and owned by the same assignee of the present invention, and they realize an optimal achievement when combined with the present invention. However, it is to be noted that the image matching techniques which can be adopted in the present embodiments are not limited to this. A specific description of the image processing technology using the base technology will be given with reference to FIG. 19 and subsequent figures.

### EMBODIMENTS OF THE BASE TECHNOLOGY

Elemental techniques of the base technology will be first described in [1]. A concrete description of a processing procedure will then be given in [2], and experimental results will be reported in [3].

[1] Detailed Description of Elemental Techniques

[1.1] Introduction

Using a set of new multiresolutional filters called critical point filters, image matching is accurately computed. There is no need for any prior knowledge concerning objects in question. The matching of the images is computed at each resolution while proceeding through the resolution hierarchy. The resolution hierarchy proceeds from a coarse level to a fine level. Parameters necessary for the computation are set completely automatically by dynamical computation analogous to human visual systems. Thus, There is no need to manually specify the correspondence of points between the images.

The base technology can be applied to, for instance, completely automated morphing, object recognition, stereo photogrammetry, volume rendering, smooth generation of motion images from a small number of frames. When applied to the morphing, given images can be automatically transformed. When applied to the volume rendering, intermediate images between cross sections can be accurately reconstructed, even when the distance between them is rather long and the cross sections vary widely in shape.

[1.2] The Hierarchy of the Critical Point Filters

The multiresolutional filters according to the base technology can preserve the intensity and locations of each critical point included in the images while reducing the resolution. Now, let the width of the image be N and the height of the image be M. For simplicity, assume that N=M=2n where n is a positive integer. An interval [0, N]⊂R is denoted by I. A pixel of the image at position (i, j) is denoted by p^{(i,j)} where i,jεI.

Here, a multiresolutional hierarchy is introduced. Hierarchized image groups are produced by a multiresolutional filter. The multiresolutional filter carries out a two dimensional search on an original image and acquires critical points therefrom. The multiresolutional filter then extracts the critical points from the original image to construct another image having a lower resolution. Here, the size of each of the respective images of the m-th level is denoted as 2^{m}×2^{m} (0 m n). A critical point filter constructs the following four new hierarchical images recursively, in the direction descending from n.

$$\begin{matrix}{p}_{( i , j )}^{( m , 0 )} = min ( min ( {p}_{( 2 i , 2 j )}^{( m + 1 , 0 )} , {p}_{( 2 i , 2 j + 1 )}^{( m + 1 , 0 )} ) , min ( {p}_{( 2 i + 1 , 2 j )}^{( m + 1 , 0 )} , {p}_{( 2 i + 1 , 2 + 1 )}^{( m + 1 , 0 )} ) ) \\ {p}_{( i , j )}^{( m , 1 )} = max ( min ( {p}_{( 2 i , 2 j )}^{( m + 1 , 1 )} , {p}_{( 2 i , 2 j + 1 )}^{( m + 1 , 1 )} ) , min ( {p}_{( 2 i + 1 , 2 j )}^{( m + 1 , 1 )} , {p}_{( 2 i + 1 , 2 j + 1 )}^{( m + 1 , 1 ) } ) ) \\ {p}_{( i , j )}^{( m , 2 )} = min ( max ( {p}_{( 2 i , 2 j )}^{( m + 1 , 2 )} , {p}_{( 2 i , 2 j + 1 )}^{( m + 1 , 2 )} ) , max ( {p}_{( 2 i + 1 , 2 j )}^{( m + 1 , 2 )} , {p}_{( 2 i + 1 , 2 j + 1 )}^{( m + 1 , 2 )} ) ) \\ {p}_{( i , j )}^{( m , 3 )} = max ( max ( {p}_{( 2 i , 2 j )}^{( m + 1 , 3 )} , {p}_{( 2 i , 2 j + 1 )}^{( m + 1 , 3 )} ) , max ( {p}_{( 2 i + 1 , 2 j )}^{( m + 1 , 3 )} , {p}_{( 2 i + 1 , 2 j + 1 )}^{( m + 1 , 3 )} ) ) & ( 1 ) \\ where let & \\ {p}_{( i , j )}^{( n , 0 )} = {p}_{( i , j )}^{( n , 1 )} = {p}_{( i , j )}^{( n , 2 )} = {p}_{( i , j )}^{( n , 3 )} = {p}_{( i , j )} & ( 2 )\end{matrix}$$

The above four images are referred to as subimages hereinafter. When min_{x≦t≦x+1} and max_{x≦t≦x+1} are abbreviated to and α and β, respectively, the subimages can be expressed as follows.

P^{(m,0)}=α(x)α(y)p^{(m+1,0)}

P^{(m,1)}=α(x)β(y)p^{(m+1,1)}

P^{(m,2)}=β(x)α(y)p^{(m+1,2)}

P^{(m,2)}=β(x)β(y)p^{(m+1,3)}

Namely, they can be considered analogous to the tensor products of α and β. The subimages correspond to the respective critical points. As is apparent from the above equations, the critical point filter acquires a critical point of the original image for every block consisting of 2×2 pixels. In this acquire ion, a point having a maximum pixel value and a point having a minimum pixel value are searched with respect to two directions, namely, vertical and horizontal directions, in each block. Although pixel intensity is used as a pixel value in this base technology, various other values relating to the image may be used. A pixel having the maximum pixel values for the two directions, one having minimum pixel values for the two directions, and one having a minimum pixel value for one direction and a maximum pixel value for the other direction are acquired as a local maximum point, a local minimum point, and a saddle point, respectively.

By using the critical point filter, an image (1 pixel here) of a critical point acquired inside each of the respective blocks serves to represent its block image (4 pixels here). Thus, resolution of the image is reduced. From a singularity theoretical point of view, α(x)α(y) preserves the local minimum point (minima point), β(x)β(y) preserves the local maximum point (maxima point), α(x)β(y) and β(x)α(y) preserve the saddle point.

At the beginning, a critical point filtering process is applied separately to a source image and a destination image which are to be matching-computed. Thus, a series of image groups, namely, source hierarchical images and destination hierarchical images are generated. Four source hierarchical images and four destination hierarchical images are generated corresponding to the types of the critical points.

Thereafter, the source hierarchical images and the destination hierarchical images are matched in a series of the resolution levels. First, the minima points are matched using p^{(m,0)}. Next, the saddle points are matched using p^{(m,1)} based on the previous matching result for the minima points. Other saddle points are matched using p^{(m,2)}. Finally, the maxima points are matched using p^{(m,3)}.

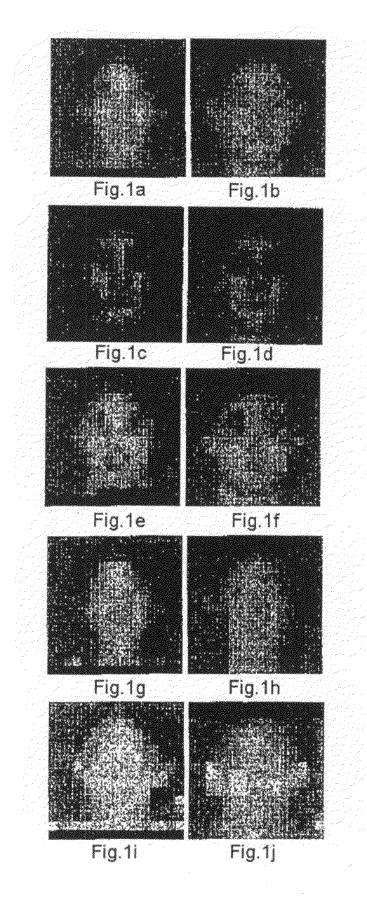

FIGS. 1(c) and 1(d) show the subimages p^{(5,0)} of the images in FIGS. 1(a) and 1(b), respectively. Similarly, FIGS. 1(e) and 1(f) show the subimages p^{(5,1)}. FIGS. 1(g) and 1(h) show the subimages p^{(5,2)}. FIGS. 1(i) and 1(j) show the subimages p^{(5,3)}. Characteristic parts in the images can be easily matched using subimages. The eyes can be matched by p^{(5,0)} since the eyes are the minima points of pixel intensity in a face. The mouths can be matched by p^{(5,1)} since the mouths have low intensity in the horizontal direction. Vertical lines on the both sides of the necks become clear by p^{(5,2)}. The ears and bright parts of cheeks become clear by p^{(5,3)} since these are the maxima points of pixel intensity.

As described above, the characteristics of an image can be extracted by the critical point filter. Thus, by comparing, for example, the characteristics of an image shot by a camera and with the characteristics of several objects recorded in advance, an object shot by the camera can be identified.

[1.3] Computation of Mapping Between Images

The pixel of the source image at the location (i,j) is denoted by p_{(i,j)}⁽ⁿ⁾ and that of the destination image at (k,l) is denoted by q_{(k,l)}⁽ⁿ⁾ where i, j, k, lεI. The energy of the mapping between the images (described later) is then defined. This energy is determined by the difference in the intensity of the pixel of the source image and its corresponding pixel of the destination image and the smoothness of the mapping. First, the mapping f^{(m,0)}:p^{(m,0)}→q^{(m,0)} between p^{(m,0)} and q^{(m,0)} with the minimum energy is computed. Based on f^{(m,0)}, the mapping f^{(m,1)} between p^{(m,1)} and q^{(m,1)} with the minimum energy is computed. This process continues until f^{(m,3)} between p^{(m,3)} and q^{(m,3)} is computed. Each f^{(m,i)} (i=0, 1, 2, . . . ) is referred to as a submapping. The order of i will be rearranged as shown in the following (3) in computing f^{(m,i)} for the reasons to be described later.

f^{(m,j)}:p^{(m,σ(i))→q}^{(m,σ(i))} (3)

where σ(i)ε{0, 1, 2, 3}.

[1.3.1] Bijectivity

When the matching between a source image and a destination image is expressed by means of a mapping, that mapping shall satisfy the Bijectivity Conditions (BC) between the two images (note that a one-to-one surjective mapping is called a bijection). This is because the respective images should be connected satisfying both surjection and injection, and there is no conceptual supremacy existing between these images. It is to be to be noted that the mappings to be constructed here are the digital version of the bijection. In the base technology, a pixel is specified by a grid point.

The mapping of the source subimage (a subimage of a source image) to the destination subimage (a subimage of a destination image) is represented by f^{(m,s)}:I/2^{n-m}×I/2^{n-m}→I/2^{n-m}×I/2^{n-m} (s=0, 1, . . . ), where f_{(i,j)}^{(m,s)}=(k,l) means that p_{(k,j)}^{(m,i)} of the source image is mapped to q_{(k,j)}^{(m,s)} of the destination image. For simplicity, when f(i,j)=(k,l) holds, a pixel q_{(k,l)} is denoted by q_{f(i,j)}.

When the data sets are discrete as image pixels (grid points) treated in the base technology, the definition of bijectivity is important. Here, the bijection will be defined in the following manner, where i, i′, j, j′, k and l are all integers. First, each square region (4)

p_{(i,j)}^{(m,s)}p_{(i+1,j)}^{(m,s)}p_{(i+1,j+1)}^{(m,s)}p_{(i,j+1})^{(m,s)} (4)

on the source image plane denoted by R is considered, where i=0, . . . , 2^{m}−1, and j=0, . . . , 2^{m-1}. The edges of R are directed as follows.

$$\vec{{p}_{( i , j )}^{( m , s )} {p}_{( i + 1 , j )}^{( m , s )}} , \vec{{p}_{( i + 1 , j )}^{( m , s )} {p}_{( i + 1 , j + 1 )}^{( m , s )}} , \vec{{p}_{( i + 1 , j + 1 )}^{( m , s )} {p}_{( i , j + 1 )}^{( m , s )}} \\ and \\ \vec{{p}_{( i , j + 1 )}^{( m , s )} {p}_{( i , j )}^{( m , s )}} \qquad ( 5 )$$

This square will be mapped by f to a quadrilateral on the destination image plane. The quadrilateral (6)

q_{(i,j)}^{(m,s)}q_{(i+1,j)}^{(m,s)}q_{(i+1,j+1)}^{(m,s)}q_{(i,j+1)}^{(m,s)} (6)

denoted by f^{(m,s)} (R) should satisfy the following bijectivity conditions (BC).

$$( So , {f}^{( m , s )} ( R ) = {f}^{( m , s )} ( {p}_{( i , j )}^{( m , s )} {p}_{( i + 1 , j )}^{( m , s )} {p}_{( i + 1 , j + 1 )}^{( m , s )} {p}_{( i , j + 1 )}^{( m , s )} ) = {q}_{( i , j )}^{( m , s )} {q}_{( i + 1 , j )}^{( m , s )} {q}_{( i + 1 , j + 1 )}^{( m , s )} {q}_{( i , j + 1 )}^{( m , s )} )$$

1. The edges of the quadrilateral f^{(m,s)} (R) should not intersect one another.

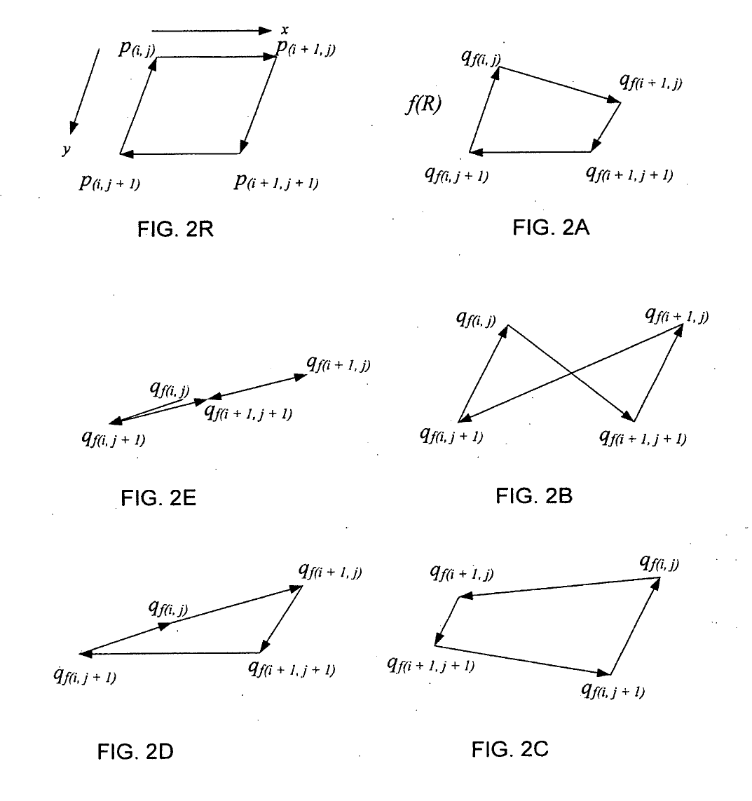

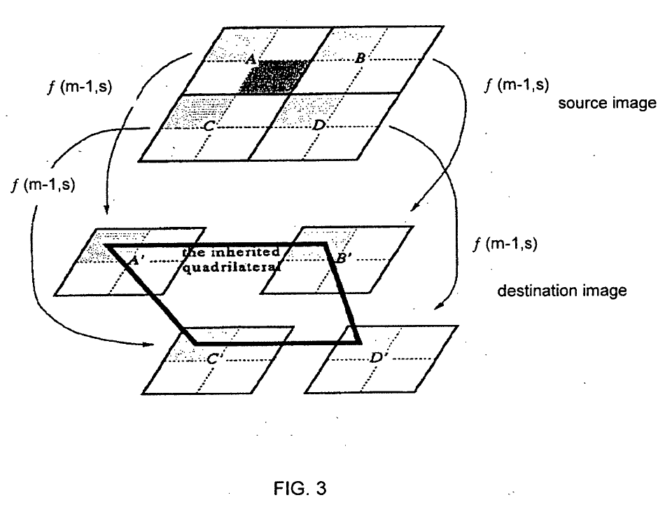

2. The orientation of the edges of f^{(m,s)} (R) should be the same as that of R (clockwise in the case of FIG. 2).

3. As a relaxed condition, retraction mapping is allowed.

The bijectivity conditions stated above shall be simply referred to as BC hereinafter.

Without a certain type of a relaxed condition, there would be no mappings which completely satisfy the BC other than a trivial identity mapping. Here, the length of a single edge of f^{(m,s)} (R) may be zero. Namely, f^{(m,s)} (R) may be a triangle. However, it is not allowed to be a point or a line segment having area zero. Specifically speaking, if FIG. 2(R) is the original quadrilateral, FIGS. 2(A) and 2(D) satisfy BC while FIGS. 2(B), 2(C) and 2(E) do not satisfy BC.

In actual implementation, the following condition may be further imposed to easily guarantee that the mapping is surjective. Namely, each pixel on the boundary of the source image is mapped to the pixel that occupies the same locations at the destination image. In other words, f(i,j)=(i,j) (on the four lines of i=0, i=2^{m}−1, j=0, j=2^{m}−1). This condition will be hereinafter referred to as an additional condition.

[1.3.2] Energy of Mapping

[1.3.2.1] Cost Related to the Pixel Intensity

The energy of the mapping f is defined. An objective here is to search a mapping whose energy becomes minimum. The energy is determined mainly by the difference in the intensity of between the pixel of the source image and its corresponding pixel of the destination image. Namely, the energy C_{(i,j)}^{(m,s)} of the mapping f^{(m,s)} at (i,j) is determined by the following equation (7).

C_{(i,j)}^{(m,s)}=|V(p_{(i,j)}^{(m,s)})−V(q_{f(i,j)}^{(m,s)})|² (7)

where V(p_{(i,j)}^{(m,s)}) and V(q_{f(i,j)}^{(m,s)}) are the intensity values of the pixels p_{(i,j)}^{(m,s)} and q_{f(i,j)}^{(m,s)}, respectively. The total energy C^{(m,s)} of f is a matching evaluation equation, and can be defined as the sum of C_{(i,j)}^{(m,s)} as shown in the following equation (8).

$${C}_{f}^{( m , s )} = {\sum }_{i = 0}^{i = {2}^{m} - 1} {{\sum }_{j = 0}}^{j = {2}^{m} - 1} {C}_{( i , j )}^{( m , s )} \qquad ( 8 )$$

[1.3.2.2] Cost Related to the Locations of the Pixel for Smooth Mapping

In order to obtain smooth mappings, another energy D_{f} for the mapping is introduced. The energy D_{f} is determined by the locations of p_{(i,j)}^{(m,s)} and q_{f(i,j)}^{(m,s)} (i=0, 1, . . . , 2^{m}−1, j=0, 1, . . . , 2^{m}−1), regardless of the intensity of the pixels. The energy D_{(i,j)}^{(m,s)} of the mapping f^{(m,s)} at a point (i,j) is determined by the following equation (9).

D_{(i,j)}^{(m,s)}=ηE_{0(i,j)}^{(m,s)}+E_{1(i,j)}^{(m,s)} (9)

where the coefficient parameter η which is equal to or greater than 0 is a real number. And we have

$$\begin{matrix}{E}_{0 ( i , j )}^{( m , s )} = {‖ ( i , j ) - {f}^{( m , s )} ( i , j ) ‖}^{2} & ( 10 ) \\ {E}_{1 ( i , j )}^{( m , s )} = {\sum }_{{i}^{′} = i - 1}^{i} {\sum }_{{j}^{′} = j - 1}^{j} {‖ \begin{matrix}( {f}^{( m , s )} ( i , j ) - ( i , j ) ) - \\ ( {f}^{( m , s )} ( {i}^{′} , {j}^{′} ) - ( {i}^{′} , {j}^{′} ) )\end{matrix} ‖}^{2} / 4 & ( 11 )\end{matrix}$$

where ∥(x,y)∥=\sqrt{x²+y²} - - - (12) and f(i′,j′) is defined to be zero for i′<0 and j′<0. E₀ is determined by the distance between (i,j) and f(i,j). E₀ prevents a pixel from being mapped to a pixel too far away from it. However, E₀ will be replaced later by another energy function. E₁ ensures the smoothness of the mapping. E₁ represents a distance between the displacement of p(i,j) and the displacement of its neighboring points. Based on the above consideration, another evaluation equation for evaluating the matching, or the energy D_{f} is determined by the following equation (13).

$${D}_{f}^{( m , s )} = {\sum }_{i = 0}^{i = {2}^{m} - 1} {\sum }_{j = 0}^{j = {2}^{m} - 1} {D}_{( i , j )}^{( m , s )} \qquad ( 13 )$$

[1.3.2.3] Total Energy of the Mapping

The total energy of the mapping, that is, a combined evaluation equation which relates to the combination of a plurality of evaluations, is defined as λC_{(i,j)}^{(m,s)}+D_{f}^{(m,s)}, where λ≧0 is a real number. The goal is to detect a state in which the combined evaluation equation has an extreme value, namely, to find a mapping which gives the minimum energy expressed by the following (14).

$${min}_{f} \{ λ {C}_{f}^{( m , s )} + {D}_{f}^{( m , s )} \} \qquad ( 14 )$$

Care must be exercised in that the mapping becomes an identity mapping if λ=0 and η=0 (i.e., f^{(m,s)} (i,j)=(i,j) for all i=0, 1, . . . , 2^{m}−1 and j=0, 1, . . . , 2^{m}−1). As will be described later, the mapping can be gradually modified or transformed from an identity mapping since the case of λ=0 and η=0 is evaluated at the outset in the base technology. If the combined evaluation equation is defined as C_{f}^{(m,s)}+λD_{f}^{(m,s)} where the original position of λ is changed as such, the equation with λ=0 and η=0 will be C_{f}^{(m,s)} only. As a result thereof, pixels would be randomly corresponded to each other only because their pixel intensities are close, thus making the mapping totally meaningless. Transforming the mapping based on such a meaningless mapping makes no sense. Thus, the coefficient parameter is so determined that the identity mapping is initially selected for the evaluation as the best mapping.

Similar to this base technology, the difference in the pixel intensity and smoothness is considered in the optical flow technique. However, the optical flow technique cannot be used for image transformation since the optical flow technique takes into account only the local movement of an object. Global correspondence can be detected by utilizing the critical point filter according to the base technology.

[1.3.3] Determining the Mapping with Multiresolution

A mapping fₘᵢₙ which gives the minimum energy and satisfies the BC is searched by using the multiresolution hierarchy. The mapping between the source subimage and the destination subimage at each level of the resolution is computed. Starting from the top of the resolution hierarchy (i.e., the coarsest level), the mapping is determined at each resolution level, while mappings at other level is being considered. The number of candidate mappings at each level is restricted by using the mappings at an upper (i.e., coarser) level of the hierarchy. More specifically speaking, in the course of determining a mapping at a certain level, the mapping obtained at the coarser level by one is imposed as a sort of constraint conditions.

Now, when the following equation (15) holds,

$$( {i}^{′} , {j}^{′} ) = ( ⌊ \frac{i}{2} ⌋ , ⌊ \frac{j}{2} ⌋ ) \qquad ( 15 )$$

p_{(i′,j′)}^{(m-1,s)} and q_{(i′,j′)}^{(m-1,s)} are respectively called the parents of p_{(i,j)}^{(m,s)} and q_{(i,j)}^{(m,s)}, where └x┘ denotes the largest integer not exceeding x. Conversely, p_{(i,j)}^{(m,s)} and q_{(i,j)}^{(m,s)} are the child of p and the child of q_{(i′,j′)}^{(m-1,s)}, respectively. A function parent(i,j) is defined by the following (16).

$$parent ( i , j ) = ( ⌊ \frac{i}{2} ⌋ , ⌊ \frac{j}{2} ⌋ ) \qquad ( 16 )$$

A mapping between p_{(i,j)}^{(m,s)} and q_{(k,j)}^{(m,s)} is determined by computing the energy and finding the minimum thereof. The value of f^{(m,s)} (i,j)=(k,l) is determined as follows using f(m−1,s) (m=1, 2, . . . , n). First of all, imposed is a condition that q_{(k,j)}^{(m,s)} should lie inside a quadrilateral defined by the following (17) and (18). Then, the applicable mappings are narrowed down by selecting ones that are thought to be reasonable or natural among them satisfying the BC.

$$\begin{matrix} {q}_{{g}^{( m , s )} ( i - 1 , j - 1 )}^{( m , s )} {q}_{{g}^{( m , s )} ( i - 1 , j + 1 )}^{( m , s )} {q}_{{g}^{( m , s )} ( i + 1 , j + 1 )}^{( m , s )} {q}_{{g}^{( m , s )} ( i + 1 , j - 1 )}^{( m , s )} \\ where & ( 17 ) \\ {g}^{( m , s )} ( i , j ) = {f}^{( m - 1 , s )} ( parent ( i , j ) ) + {f}^{( m - 1 , s )} ( parent ( i , j ) + ( 1 , 1 ) ) & ( 18 )\end{matrix}$$

The quadrilateral defined above is hereinafter referred to as the inherited quadrilateral of p_{(i,j)}^{(m,s)}. The pixel minimizing the energy is sought and obtained inside the inherited quadrilateral.

FIG. 3 illustrates the above-described procedures. The pixels A, B, C and D of the source image are mapped to A′, B′, C′ and D′ of the destination image, respectively, at the (m−1)th level in the hierarchy. The pixel p_{(i,j)}^{(m,s)} should be mapped to the pixel q_{f}_{^{(m)}}_{(i,j)}^{(m,s)} which exists inside the inherited quadrilateral A′B′ C′D′. Thereby, bridging from the mapping at the (m−1)th level to the mapping at the m-th level is achieved.

The energy E₀ defined above is now replaced by the following (19) and (20)

E_{0(i,j)}=∥f^{(m,0)}(i,j)−g^{(m)}(i,j)∥² (19)

E_{0(i,j)}=∥f^{(m,s)}(i,j)−f^{(m,s-1)}(i,j)∥²,(1≦i) (20)

for computing the submapping f^{(m,0)} and the submapping f^{(m,s)} at the m-th level, respectively.

In this manner, a mapping which keeps low the energy of all the submappings is obtained. Using the equation (20) makes the submappings corresponding to the different critical points associated to each other within the same level in order that the subimages can have high similarity. The equation (19) represents the distance between f^{(m,s)} (i,j) and the location where (i,j) should be mapped when regarded as a part of a pixel at the (m−1)th level.

When there is no pixel satisfying the BC inside the inherited quadrilateral A′B′C′D′, the following steps are taken. First, pixels whose distance from the boundary of A′B′C′D′ is L (at first, L=1) are examined. If a pixel whose energy is the minimum among them satisfies the BC, then this pixel will be selected as a value of f^{(m,s)} (i,j). L is increased until such a pixel is found or L reaches its upper bound Lₘₐₓ^{(m)}. Lₘₐₓ^{(m)} is fixed for each level m. If no such a pixel is found at all, the third condition of the BC is ignored temporarily and such mappings that caused the area of the transformed quadrilateral to become zero (a point or a line) will be permitted so as to determine f^{(m,s)} (i,j). If such a pixel is still not found, then the first and the second conditions of the BC will be removed.

Multiresolution approximation is essential to determining the global correspondence of the images while preventing the mapping from being affected by small details of the images. Without the multiresolution approximation, it is impossible to detect a correspondence between pixels whose distances are large. In the case where the multiresolution approximation is not available, the size of an image will be limited to the very small one, and only tiny changes in the images can be handled. Moreover, imposing smoothness on the mapping usually makes it difficult to find the correspondence of such pixels. That is because the energy of the mapping from one pixel to another pixel which is far therefrom is high. On the other hand, the multiresolution approximation enables finding the approximate correspondence of such pixels. This is because the distance between the pixels is small at the upper (coarser) level of the hierarchy of the resolution.

[1.4] Automatic Determination of the Optimal Parameter Values

One of the main deficiencies of the existing image matching techniques lies in the difficulty of parameter adjustment. In most cases, the parameter adjustment is performed manually and it is extremely difficult to select the optical value. However, according to the base technology, the optimal parameter values can be obtained completely automatically.

The systems according to this base technology includes two parameters, namely, λ and η, where λ and η represent the weight of the difference of the pixel intensity and the stiffness of the mapping, respectively. The initial value for these parameters are 0. First, λ is gradually increased from λ=0 while η is fixed to 0. As λ becomes larger and the value of the combined evaluation equation (equation (14)) is minimized, the value of C_{f}^{(m,s)} for each submapping generally becomes smaller. This basically means that the two images are matched better. However, if λ exceeds the optimal value, the following phenomena (1-4) are caused.

1. Pixels which should not be corresponded are erroneously corresponded only because their intensities are close.

2. As a result, correspondence between images becomes inaccurate, and the mapping becomes invalid.

3. As a result, D_{f}^{(m,s)} in the equation 14 tends to increase abruptly.

4. As a result, since the value of the equation 14 tends to increase abruptly, f^{(m,s)} changes in order to suppress the abrupt increase of D_{f}^{(m,s)}. As a result, C_{f}^{(m,s)} increases.

Therefore, a threshold value at which C_{f}^{(m,s)} turns to an increase from a decrease is detected while a state in which the equation (14) takes the minimum value with λ being increased is kept. Such λ is determined as the optimal value at η=0. Then, the behavior of C_{f}^{(m,s)} is examined while η is increased gradually, and η will be automatically determined by a method described later. λ will be determined corresponding to such the automatically determined η.

The above-described method resembles the focusing mechanism of human visual systems. In the human visual systems, the images of the respective right eye and left eye are matched while moving one eye. When the objects are clearly recognized, the moving eye is fixed.

[1.4.1] Dynamic Determination of λ

λ is increased from 0 at a certain interval, and the a subimage is evaluated each time the value of λ changes. As shown in the equation (14), the total energy is defined by λC_{f}^{(m,s)+D}_{f}^{(m,s)}. D_{(i,j)}^{(m,s)} in the equation (9) represents the smoothness and theoretically becomes minimum when it is the identity mapping. E₀ and E₁ increase as the mapping is further distorted. Since E₁ is an integer, 1 is the smallest step of D_{f}^{(m,s)}. Thus, that changing the mapping reduces the total energy is impossible unless a changed amount (reduction amount) of the current λC_{(i,j)}^{(m,s)} is equal to or greater than 1. Since D_{f}^{(m,s)} increases by more than 1 accompanied by the change of the mapping, the total energy is not reduced unless λC_{(i,j)}^{(m,s)} is reduced by more than 1.

Under this condition, it is shown that C_{(i,j)}^{(m,s)} decreases in normal cases as λ increases. The histogram of C_{(i,j)}^{(m,s)} is denoted as h(l), where h(l) is the number of pixels whose energy C_{(i,j)}^{(m,s)} is l₂. In order that λl²≧1, for example, the case of l²=1/λ is considered. When λ varies from λ₁ to λ₂, a number of pixels (denoted A) expressed by the following (21)

$$\begin{matrix}A = {\sum }_{l = ⌈ \frac{1}{{λ}_{2}} ⌉}^{⌊ \frac{1}{{λ}_{1}} ⌋} h ( l ) \\ ≅ {\int }_{l = \frac{1}{{λ}_{2}}}^{\frac{1}{{λ}_{1}}} h ( l ) d l \\ = - {\int }_{{λ}_{2}}^{{λ}_{1}} h ( l ) \frac{1}{{λ}^{3 / 2}} d λ \\ = {\int }_{{λ}_{1}}^{{λ}_{2}} \frac{h ( l )}{{λ}^{3 / 2}} d λ\end{matrix} \qquad ( 21 )$$

changes to a more stable state having the energy (22) which is

$${C}_{f}^{( m , s )} - {l}^{2} = {C}_{f}^{( m , s )} - \frac{1}{λ} . \qquad ( 22 )$$

Here, it is assumed that all the energy of these pixels is approximated to be zero. It means that the value of C_{(i,j)}^{(m,s)} changes by (23).

$$\partial {C}_{f}^{( m , s )} = - \frac{A}{λ} \qquad ( 23 )$$

As a result, the equation (24) holds.

$$\frac{\partial {C}_{f}^{( m , s )}}{\partial λ} = - \frac{h ( l )}{{λ}^{5 / 2}} \qquad ( 24 )$$

Since h(l)>0, C_{f}^{(m,s)} decreases in normal case. However, when λ tends to exceed the optimal value, the above phenomenon that is characterized by the increase in C_{f}^{(m,s)} occurs. The optimal value of λ is determined by detecting this phenomenon.

When

$$h ( l ) = {Hl}^{k} = \frac{H}{{λ}^{k / 2}} \qquad ( 25 )$$

is assumed where both H(h>0) and k are constants, the equation (26) holds.

$$\frac{\partial {C}_{f}^{( m , s )}}{\partial λ} = - \frac{H}{{λ}^{5 / 2 + k / 2}} \qquad ( 26 )$$

Then, if k≠−3, the following (27) holds.

$${C}_{f}^{( m , s )} = C + \frac{H}{( 3 / 2 + k / 2 ) {λ}^{3 / 2 + k / 2}} \qquad ( 27 )$$

The equation (27) is a general equation of C_{f}^{(m,s)} (where C is a constant).

When detecting the optimal value of λ, the number of pixels violating the BC may be examined for safety. In the course of determining a mapping for each pixel, the probability of violating the BC is assumed p₀ here. In that case, since

$$\frac{\partial A}{\partial λ} = \frac{h ( l )}{{λ}^{3 / 2}} \qquad ( 28 )$$

holds, the number of pixels violating the BC increases at a rate of the equation (29).

$$\begin{matrix}{B}_{0} = \frac{h ( l ) {p}_{0}}{{λ}^{3 / 2}} \\ Thus , & ( 29 ) \\ \frac{{B}_{0} {λ}^{3 / 2}}{{p}_{0} h ( l )} = 1 & ( 30 )\end{matrix}$$

is a constant. If assumed that h(l)=Hl^{k}, the following (31), for example,

B₀λ^{3/2+k/2}=p₀H (31)

becomes a constant. However, when λ exceeds the optimal value, the above value of (31) increases abruptly. By detecting this phenomenon, whether or not the value of B₀λ^{3/2+k/2}/2^{m} exceeds an abnormal value B₀ₜₕᵣₑₛ exceeds is inspected, so that the optimal value of can be determined. Similarly, whether or not the value of B₁λ^{3/2+k/2}/2^{m} exceeds an abnormal value B₁ₜₕᵣₑₛ, so that the increasing rate B₁ of pixels violating the third condition of the BC is checked. The reason why the fact 2^{m} is introduced here will be described at a later stage. This system is not sensitive to the two threshold values B₀ₜₕᵣₑₛ and B₁ₜₕᵣₑₛ. The two threshold values B₀ₜₕᵣₑₛ and B₁ₜₕᵣₑₛ can be used to detect the excessive distortion of the mapping which is failed to be detected through the observation of the energy C_{f}^{(m,s)}.

In the experimentation, the computation of f^{(m,s)} is stopped and then the computation of f^{(m,s+1)} is started when λ exceeded 0.1. That is because the computation of submappings is affected by the difference of mere 3 out of 255 levels in the pixel intensity when λ>0.1, and it is difficult to obtain a correct result when λ>0.1.

[1.4.2] Histogram h(l)

The examination of C_{f}^{(m,s)} does not depend on the histogram h(l). The examination of the BC and its third condition may be affected by the h(l). k is usually close to 1 when (λ, C_{f}^{(m,s)}) is actually plotted. In the experiment, k=1 is used, that is, B₀λ² and B₁λ² are examined. If the true value of k is less than 1, B₀λ² and B₁λ² does not become constants and increase gradually by the factor of λ^{(1-k)/2}. If h(l) is a constant, the factor is, for example, λ^{1/2}. However, such a difference can be absorbed by setting the threshold B₀ₜₕᵣₑₛ appropriately.

Let us model the source image by a circular object with its center at (x₀,y₀) and its radius r, given by:

$$p ( i , j ) = \{ \begin{matrix}\frac{255}{r} c ( \sqrt{{( i - {x}_{0} )}^{2} + {( j - {y}_{0} )}^{2}} ) … ( \sqrt{{( i - {x}_{0} )}^{2} + {( j - {y}_{0} )}^{2}} \leq r ) \\ 0 … ( otherwise )\end{matrix} \qquad ( 32 )$$

and the destination image given by:

$$q ( i , j ) = \{ \begin{matrix}\frac{255}{r} c ( \sqrt{\begin{matrix}{( i - {x}_{1} )}^{2} + \\ {( j - {y}_{1} )}^{2}\end{matrix}} … ( \sqrt{\begin{matrix}{( i - {x}_{1} )}^{2} + \\ {( j - {y}_{1} )}^{2}\end{matrix}} \leq r ) \\ 0 … ( otherwise )\end{matrix} \qquad ( 33 )$$

with its center at (x₁,y₁) and radius r. Let c(x) has the form of c(x)=x^{k}. When the centers (x₀,y₀) and (x₁,y₁) are sufficiently far from each other, the histogram h(l) is then in the form of:

h(l)∝rl^{k}(k≠0) (34)

When k=1, the images represent objects with clear boundaries embedded in the backgrounds. These objects become darker toward their centers and brighter toward their boundaries. When k=−1, the images represent objects with vague boundaries. These objects are brightest at their centers, and become darker toward boundaries. Without much loss of generality, it suffices to state that objects in general are between these two types of objects. Thus, k such that −1≦k≦1 can cover the most cases, and it is guaranteed that the equation (27) is generally a decreasing function.

As can be observed from the above equation (34), attention must be directed to the fact that r is influenced by the resolution of the image, namely, r is proportional to 2^{m}. That is why the factor 2^{m} was introduced in the above section [1.4.1].

[1.4.3] Dynamic Determination of η

The parameter η can also be automatically determined in the same manner. Initially, η is set to zero, and the final mapping f⁽ⁿ⁾ and the energy C_{f}⁽ⁿ⁾ at the finest resolution are computed. Then, after η is increased by a certain value Δη and the final mapping f⁽ⁿ⁾ and the energy C_{f}⁽ⁿ⁾ at the finest resolution are again computed. This process is repeated until the optimal value is obtained. η represents the stiffness of the mapping because it is a weight of the following equation (35).

E_{0(i,j)}^{(m,s)}=∥f^{(m,s)}(i,j)−f^{(m,s-1)}(i,j)∥² (35)

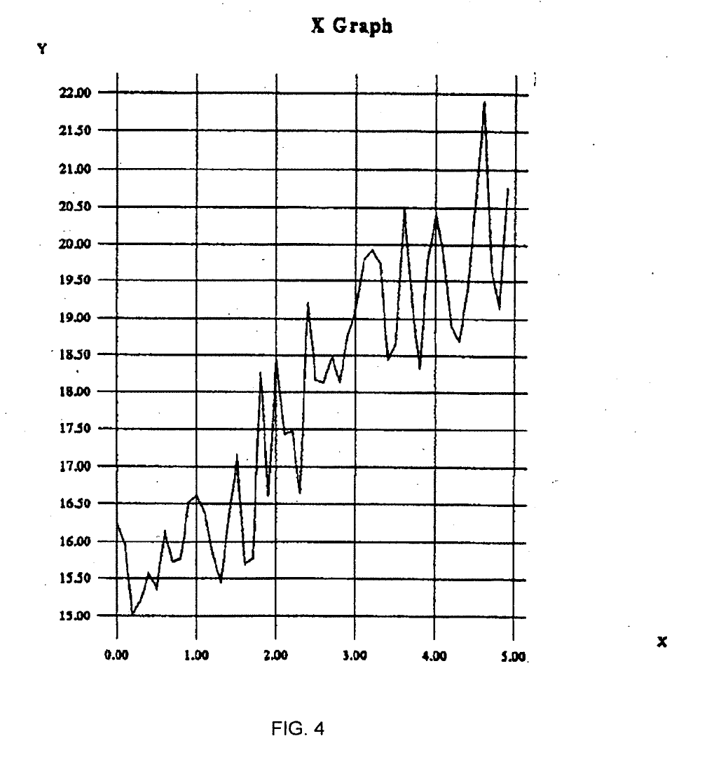

When η is zero, D_{f}⁽ⁿ⁾ is determined irrespective of the previous submapping, and the present submapping would be elastically deformed and become too distorted. On the other hand, when η is a very large value, D_{f}⁽ⁿ⁾ is almost completely determined by the immediately previous submapping. The submappings are then very stiff, and the pixels are mapped to almost the same locations. The resulting mapping is therefore the identity mapping. When the value of η increases from 0, C_{f}⁽ⁿ⁾ gradually decreases as will be described later. However, when the value of η exceeds the optimal value, the energy starts increasing as shown in FIG. 4. In FIG. 4, the x-axis represents η, and y-axis represents C_{f}.

The optimum value of η which minimizes C_{f}⁽ⁿ⁾ can be obtained in this manner. However, since various elements affects the computation compared to the case of λ, C_{f}⁽ⁿ⁾ changes while slightly fluctuating. This difference is caused because a submapping is re-computed once in the case of λ whenever an input changes slightly, whereas all the submappings must be re-computed in the case of n. Thus, whether the obtained value of C_{f}⁽ⁿ⁾ is the minimum or not cannot be judged instantly. When candidates for the minimum value are found, the true minimum needs to be searched by setting up further finer interval.

[1.5] Supersampling

When deciding the correspondence between the pixels, the range of f^{(m,s)} can be expanded to R×R (R being the set of real numbers) in order to increase the degree of freedom.

In this case, the intensity of the pixels of the destination image is interpolated, so that f^{(m,s)} having the intensity at non-integer points

V(q_{f}_{^{(m,s)}}_{(i,j)}^{(m,s)} (36)

is provided. Namely, supersampling is performed. In its actual implementation, f^{(m,s)} is allowed to take integer and half integer values, and

V(q_{(i,j)+(0.5,0.5)}^{(m,s)}) (37)

is given by

(V(q_{(i,j)}^{(m,s)}+V(q_{(i,j)+(1,1)}^{(m,s)}))/2 (38)

[1.6] Normalization of the Pixel Intensity of Each Image

When the source and destination images contain quite different objects, the raw pixel intensity may not be used to compute the mapping because a large difference in the pixel intensity causes excessively large energy C_{f}^{(m,s)} relating the intensity, thus making it difficult to perform the correct evaluation.

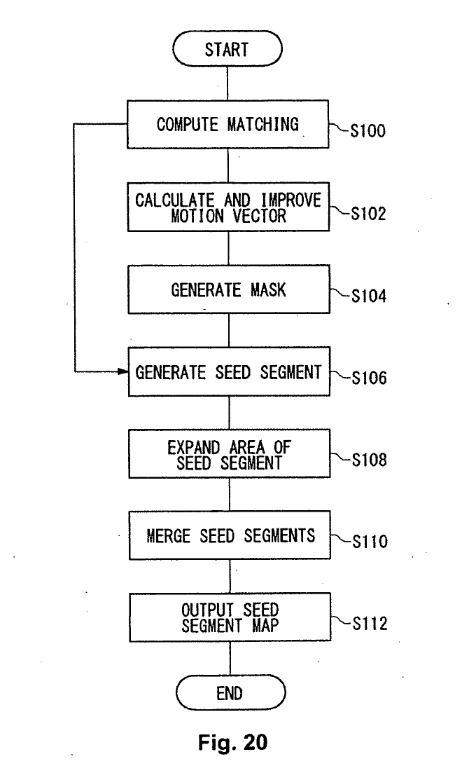

For example, the matching between a human face and a cat's face is computed as shown in FIGS. 20(a) and 20(b). The cat's face is covered with hair and is a mixture of very bright pixels and very dark pixels. In this case, in order to compute the submappings of the two faces, its subimages are normalized. Namely, the darkest pixel intensity is set to 0 while the brightest pixel intensity is set to 255, and other pixel intensity values are obtained using the linear interpolation.

[1.7] Implementation

In the implementation, utilized is a heuristic method where the computation proceeds linearly as the source image is scanned. First, the value of f^{(m,s)} is determined at the top leftmost pixel (i,j)=(0,0). The value of each f^{(m,s)} (i,j) is then determined while i is increased by one at each step. When i reaches the width of the image, j is increased by one and i is reset to zero. Thereafter, f^{(m,s)} (i,j) is determined while scanning the source image. Once pixel correspondence is determined for all the points, it means that a single mapping f^{(m,s)} is determined.

When a corresponding point q_{f(i,j)} is determined for p_{(i,j)}, a corresponding point q_{f(i,j+1)} of p_{(i,j+1)} is determined next. The position of q_{f(i,j+1)} is constrained by the position of q_{f(i,j)} since the position of q_{f(i,j+1)} satisfies the BC. Thus, in this system, a point whose corresponding point is determined earlier is given higher priority. If the situation continues in which (0,0) is always given the highest priority, the final mapping might be unnecessarily biased. In order to avoid this bias, f^{(m,s)} is determined in the following manner in the base technology.

First, when (s mod 4) is 0, f^{(m,s)} is determined starting from (0,0) while gradually increasing both i and j. When (s mod 4) is 1, it is determined starting from the top rightmost location while decreasing i and increasing j. When (s mod 4) is 2, it is determined starting from the bottom rightmost location while decreasing both i and j. When (s mod 4) is 3, it is determined starting from the bottom leftmost location while increasing i and decreasing j. Since a concept such as the submapping, that is, a parameter s, does not exist in the finest n-th level, f^{(m,s)} is computed continuously in two directions on the assumption that s=0 and s=2.

In the actual implementation, the values of f^{(m,s)} (i,j) (m=0, . . . , n) that satisfy the BC are chosen as much as possible, from the candidates (k,l) by awarding a penalty to the candidates violating the BC. The energy D_{(k,l)} of the candidate that violates the third condition of the BC is multiplied by φ and that of a candidate that violates the first or second condition of the BC is multiplied by φ. In the actual implementation, φ=2 and φ=100000 are used.

In order to check the above-mentioned BC, the following test is performed as the actual procedure when determining (k,l)=f^{(m,s)} (i,j). Namely, for each grid point (k,l) in the inherited quadrilateral of f^{(m,s)} (i,j), whether or not the z-component of the outer product of

$$W = {A}^{ρ} \times {B}^{ρ} \qquad ( 39 )$$

is equal to or greater than 0 is examined, where

$$\begin{matrix}{A}^{ρ} = \overline{{q}_{{f}^{( m , s )} ( i , j - 1 )}^{( m , s )} {q}_{{f}^{( m , s )} ( i + 1 , j - 1 )}^{( m , s )}} & ( 40 ) \\ {B}^{ρ} = \overline{{q}_{{f}^{( m , s )} ( i , j - 1 )}^{( m , s )} {q}_{( k , l )}^{( m , s )}} & ( 41 )\end{matrix}$$

Here, the vectors are regarded as 3D vectors and the z-axis is defined in the orthogonal right-hand coordinate system. When W is negative, the candidate is awarded a penalty by multiplying D_{(k,j)}^{(m,s)} by φ so as not to be selected as much as possible.

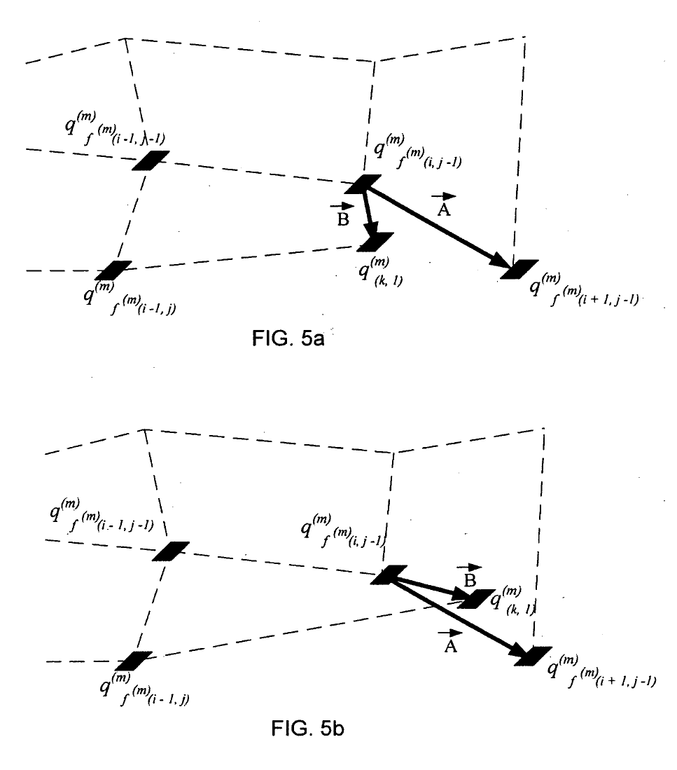

FIGS. 5(a) and 5(b) illustrate the reason why this condition is inspected. FIG. 5(a) shows a candidate without a penalty and FIG. 5(b) shows one with a penalty. When determining the mapping f^{(m,s)} (i,j+1) for the adjacent pixel at (i,j+1), there is no pixel on the source image plane that satisfies the BC if the z-component of W is negative because then q_{(k,j)}^{(m,s)} passes the boundary of the adjacent quadrilateral.

[1.7.1] The Order of Submappings

In the actual implementation, σ(0)=0, σ(1)=1, σ(2)=2, σ(3)=3, σ(4)=0 were used when the resolution level was even, while σ(0)=3, σ(1)=2, σ(2)=1, σ(3)=0, σ(4)=3 were used when the resolution level was odd. Thus, the submappings are shuffled in an approximately manner. It is to be noted that the submapping is primarily of four types, and s may be any one among 0 to 3. However, a processing with s=4 was actually performed for the reason described later.

[1.8] Interpolations

After the mapping between the source and destination images is determined, the intensity values of the corresponding pixels are interpolated. In the implementation, trilinear interpolation is used. Suppose that a square p_{(i,j)}p_{(i+1,j)}p_{(i+1,j+1)}p_{(i,j+1)} on the source image plane is mapped to a quadrilateral q_{f(i,j)}q_{f(i+1,j)}q_{f(i+1,j+1)}q_{f(i,j+1)} on the destination image plane. For simplicity, the distance between the image planes is assumed 1. The intermediate image pixels r(x,y,t) (0≦x≦N−1, 0≦y≦M−1) whose distance from the source image plane is t (0≦t≦1) are obtained as follows. First, the location of the pixel r(x,y,t), where x,y,tεR, is determined by the equation (42).

$$( x , y ) = ( 1 - dx ) ( 1 - dy ) ( 1 - t ) ( i , j ) + ( 1 - dx ) ( 1 - dy ) tf ( i , j ) + dx ( 1 - dy ) ( 1 - t ) ( i + 1 , j ) + dx ( 1 - dy ) tf ( i + 1 , j ) + ( 1 - dx ) dy ( 1 - t ) ( i , j + 1 ) + ( 1 - dx ) dytf ( i , j + 1 ) + dxdy ( 1 - t ) ( i + 1 , j + 1 ) + dxdytf ( i + 1 , j + 1 ) \qquad ( 42 )$$

The value of the pixel intensity at r(x,y,t) is then determined by the equation (43).

$$V ( r ( x , y , t ) ) = ( 1 - dx ) ( 1 - dy ) ( 1 - t ) V ( {p}_{( i , j )} ) + ( 1 - dx ) ( 1 - dy ) tV ( {q}_{f ( i , j )} ) + dx ( 1 - dy ) ( 1 - t ) V ( {p}_{( i + 1 , j )} ) + dx ( 1 - dy ) tV ( {q}_{f ( i + 1 , j )} ) + ( 1 - dx ) dy ( 1 - t ) V ( {p}_{( i , j + 1 )} ) + ( 1 - dx ) dytV ( {q}_{f ( i , j + 1 )} ) + dxdy ( 1 - t ) V ( {p}_{( i + 1 , j + 1 )} ) + dxdytV ( {q}_{f ( i + 1 , j + 1 )} ) \qquad ( 43 )$$

where dx and dy are parameters varying from 0 to 1.

[1.9] Mapping to which Constraints are Imposed

So far, the determination of the mapping to which no constraint is imposed has been described. However, when a correspondence between particular pixels of the source and destination images is provided in a predetermined manner, the mapping can be determined using such correspondence as a constraint.

The basic idea is that the source image is roughly deformed by an approximate mapping which maps the specified pixels of the source image to the specified pixels of the destination images and thereafter a mapping f is accurately computed.

First, the specified pixels of the source image are mapped to the specified pixels of the destination image, then the approximate mapping that maps other pixels of the source image to appropriate locations are determined. In other words, the mapping is such that pixels in the vicinity of the specified pixels are mapped to the locations near the position to which the specified one is mapped. Here, the approximate mapping at the m-th level in the resolution hierarchy is denoted by F^{(m)}.

The approximate mapping F is determined in the following manner. First, the mapping for several pixels are specified. When n^{s} pixels

p(i₀,j₀),p(i₁,j₁), . . . , p(iₙ_{ₛ}₋₁,jₙ_{ₛ}₋₁) (44)

of the source image are specified, the following values in the equation (45) are determined.

F⁽ⁿ⁾(i₀,j₀)=(k₀,l₀),

F⁽ⁿ⁾(i₁,j₁)=(k₁,l₁), . . . ,

F⁽ⁿ⁾(iₙ_{ₛ}₋₁,jₙ_{ₛ}₋₁)=(kₙ_{ₛ}₋₁,lₙ_{ₛ}₋₁) (45)

For the remaining pixels of the source image, the amount of displacement is the weighted average of the displacement of p(iₕ,jₕ) (h=0, . . . , nₛ₋1). Namely, a pixel p_{(i,j)} is mapped to the following pixel (expressed by the equation (46)) of the destination image.

$$\begin{matrix}{F}^{( m )} ( i , j ) = \frac{( i , j ) + {\sum }_{h = 0}^{h = {n}_{s} - 1} ( {k}_{h} - {i}_{h} , {l}_{h} - {j}_{h} ) {weight}_{h} ( i , j )}{{2}^{n - m}} \\ where & ( 46 ) \\ {weight}_{h} ( i , j ) = \frac{1 / {‖ ( {i}_{h} - i , {j}_{h} - j ) ‖}^{2}}{total\_weight ( i , j )} \\ where & ( 47 ) \\ total\_weight ( i , j ) = {\sum }_{h = 0}^{h = {n}_{s} - 1} 1 / {‖ ( {i}_{h} - i , {j}_{h} - j ) ‖}^{2} & ( 48 )\end{matrix}$$

Second, the energy D_{(i,j)}^{(m,s)} of the candidate mapping f is changed so that mapping f similar to F^{(m)} has a lower energy. Precisely speaking, D_{(i,j)}^{(m,s)} is expressed by the equation (49).

$$\begin{matrix} {D}_{( i , j )}^{( m , s )} = {E}_{{0}_{( i , j )}}^{( m , s )} + η {E}_{{1}_{( i , j )}}^{( m , s )} + κ {E}_{{2}_{( i , j )}}^{( m , s )} & ( 49 ) \\ {E}_{{2}_{( i , j )}}^{( m , s )} = \{ \begin{matrix}0 , & if {‖ {F}^{( m )} ( i , j ) - {f}^{( m , s )} ( i , j ) ‖}^{2} \leq ⌊ \frac{{ρ}^{2}}{{2}^{2 ( n - m )}} ⌋ \\ {‖ {F}^{( m )} ( i , j ) - {f}^{( m , s )} ( i , j ) ‖}^{2} , & otherwise\end{matrix} & ( 50 )\end{matrix}$$

where κ,ρ≧0. Finally, the mapping f is completely determined by the above-described automatic computing process of mappings.

Note that E₂_{_{(i,j)}}^{(m,s)} becomes 0 if f^{(m,s)} (i,j) is sufficiently close to F^{(m)} (i,j) i.e., the distance therebetween is equal to or less than

$$⌊ \frac{{ρ}^{2}}{{2}^{2 ( n - m )}} ⌋ \qquad ( 51 )$$

It is defined so because it is desirable to determine each value f^{(m,s)} (i,j) automatically to fit in an appropriate place in the destination image as long as each value f^{(m,s)} (i,j) is close to F^{(m)} (i,j). For this reason, there is no need to specify the precise correspondence in detail, and the source image is automatically mapped so that the source image matches the destination image.

[2] Concrete Processing Procedure

The flow of the process utilizing the respective elemental techniques described in [1] will be described.

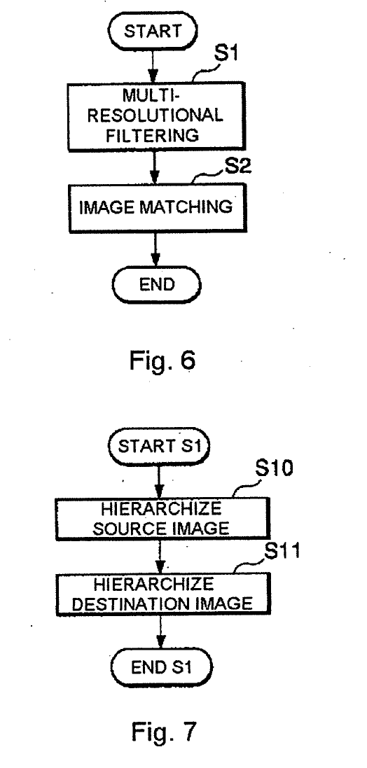

FIG. 6 is a flowchart of the entire procedure of the base technology. Referring to FIG. 6, a processing using a multiresolutional critical point filter is first performed (S1). A source image and a destination image are then matched (S2). S2 is not indispensable, and other processings such as image recognition may be performed instead, based on the characteristics of the image obtained at S1.

FIG. 7 is a flowchart showing the details of the process at S1 shown in FIG. 6. This process is performed on the assumption that a source image and a destination image are matched at S2. Thus, a source image is first hierarchized using a critical point filter (S10) so as to obtain a series of source hierarchical images. Then, a destination image is hierarchized in the similar manner (S11) so as to obtain a series of destination hierarchical images. The order of S10 and S11 in the flow is arbitrary, and the source image and the destination image can be generated in parallel.

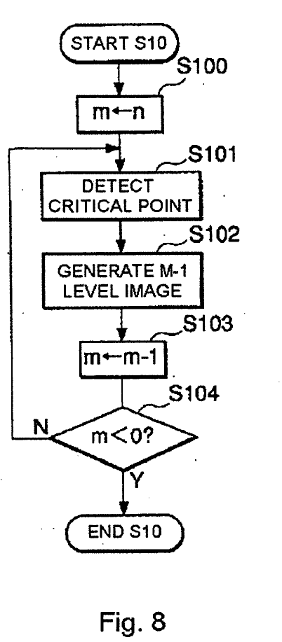

FIG. 8 is a flowchart showing the details of the process at S10 shown in FIG. 7. Suppose that the size of the original source image is 2ⁿ×2ⁿ. Since source hierarchical images are sequentially generated from one with a finer resolution to one with a coarser resolution, the parameter m which indicates the level of resolution to be processed is set to n (S100). Then, critical points are detected from the images p^{(m,0)}, p^{(m,1)}, p^{(m,2)} and p^{(m,3)} of the m-th level of resolution, using a critical point filter (S101), so that the images p^{(m-1,0)}, p^{(m-1,1)}, p^{(m-1,2)} and p^{(m-1,3)} of the (m−1)th level are generated (S102). Since m=n here, p^{(m,0)}=p^{(m,1)}=p^{(m,2)}=p^{(m,3)}=p⁽ⁿ⁾ holds and four types of subimages are thus generated from a single source image.

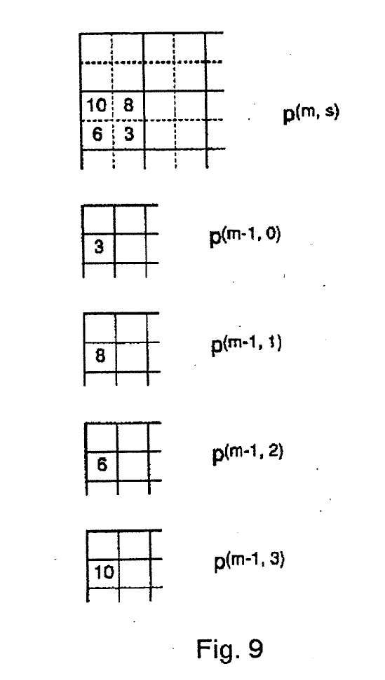

FIG. 9 shows correspondence between partial images of the m-th and those of (m−1)th levels of resolution. Referring to FIG. 9, respective values represent the intensity of respective pixels. p^{(m,s)} symbolizes four images p(m,0) through p^{(m,3)}, and when generating p^{(m-1,0)}, p^{(m,s)} is regarded as p^{(m,0)}. For example, as for the block shown in FIG. 9, comprising four pixels with their pixel intensity values indicated inside, images p^{(m-1,0)}, p^{(m-1,1)}, p^{(m-1,2)} and p^{(m-1,3)} acquire “3”, “8”, “6” and “10”, respectively, according to the rules described in [1.2]. This block at the m-th level is replaced at the (m−1)th level by respective single pixels acquired thus. Therefore, the size of the subimages at the (m−1)th level is 2^{m-1}×2^{m-1}.

After m is decremented (S103 in FIG. 8), it is ensured that m is not negative (S104). Thereafter, the process returns to S101, so that subimages of the next level of resolution, i.e., a next coarser level, are generated. The above process is repeated until subimages at m=0 (0-th level) are generated to complete the process at S10. The size of the subimages at the 0-th level is 1×1.

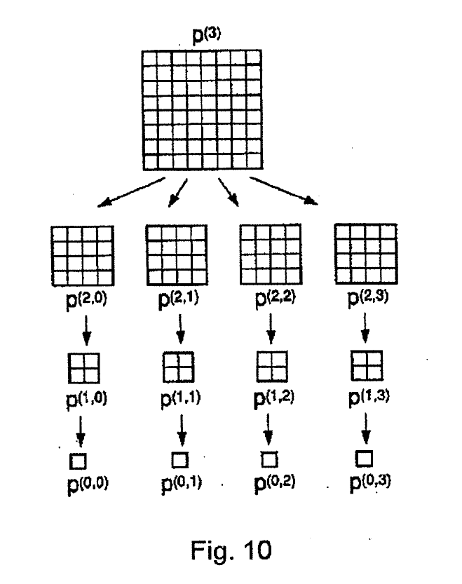

FIG. 10 shows source hierarchical images generated at S10 in the case of n=3. The initial source image is the only image common to the four series followed. The four types of subimages are generated independently, depending on the type of a critical point. Note that the process in FIG. 8 is common to S11 shown in FIG. 7, and that destination hierarchical images are generated through the similar procedure. Then, the process by S1 shown in FIG. 6 is completed.

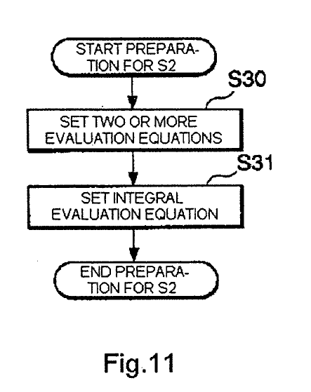

In the base technology, in order to proceed to S2 shown in FIG. 6 a matching evaluation is prepared. FIG. 11 shows the preparation procedure. Referring to FIG. 11, a plurality of evaluation equations are set (S30). Such the evaluation equations include the energy C_{f}^{(m,s)} concerning a pixel value, introduced in [1.3.2.1], and the energy D_{f}^{(m,s)} concerning the smoothness of the mapping introduced in [1.3.2.2]. Next, by combining these evaluation equations, a combined evaluation equation is set (S31). Such the combined evaluation equation includes λC_{(i,j)}^{(m,s)}+D_{f}^{(m,s)}. Using η introduced in [1.3.2.2], we have

ΣΣ(λC_{(i,j)}^{(m,s)}+ηE_{0(i,j)}^{(m,s)}+E_{1(i,j)}^{(m,s)} (52)

In the equation (52) the sum is taken for each i and j where i and j run through 0, 1, . . . , 2^{m-1}. Now, the preparation for matching evaluation is completed.

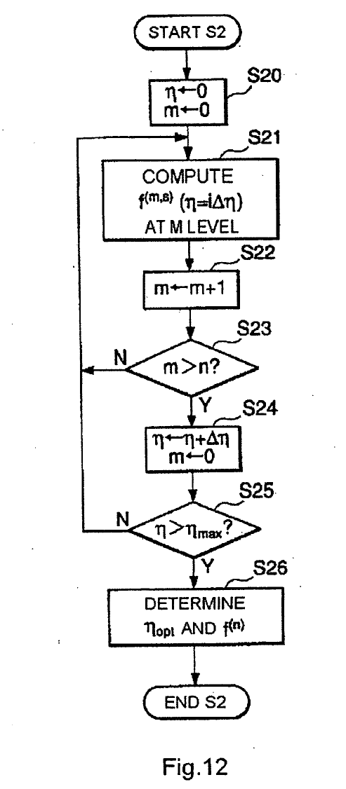

FIG. 12 is a flowchart showing the details of the process of S2 shown in FIG. 6. As described in [1], the source hierarchical images and destination hierarchical images are matched between images having the same level of resolution. In order to detect global corresponding correctly, a matching is calculated in sequence from a coarse level to a fine level of resolution. Since the source and destination hierarchical images are generated by use of the critical point filter, the location and intensity of critical points are clearly stored even at a coarse level. Thus, the result of the global matching is far superior to the conventional method.

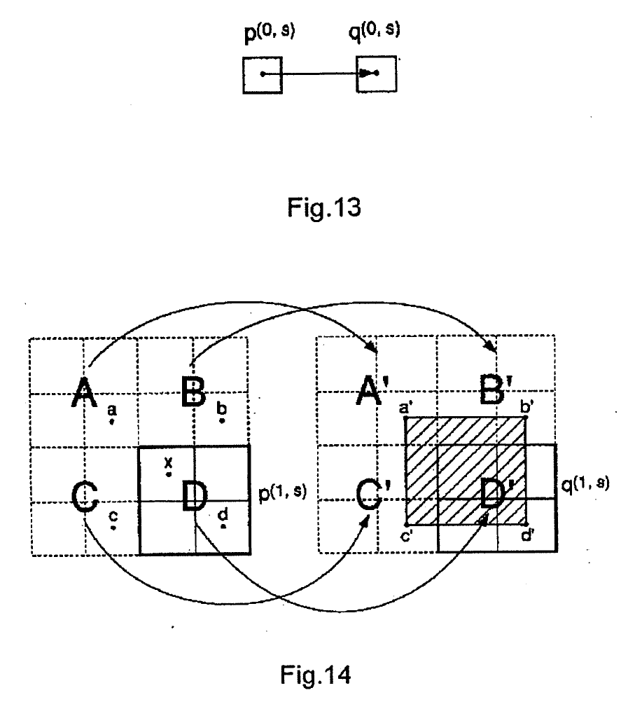

Referring to FIG. 12, a coefficient parameter η and a level parameter m are set to 0 (S20). Then, a matching is computed between respective four subimages at the m-th level of the source hierarchical images and those of the destination hierarchical images at the m-th level, so that four types of submappings f^{(m,s)} (s=0, 1, 2, 3) which satisfy the BC and minimize the energy are obtained (S21). The BC is checked by using the inherited quadrilateral described in [1.3.3]. In that case, the submappings at the m-th level are constrained by those at the (m−1)th level, as indicated by the equations (17) and (18). Thus, the matching computed at a coarser level of resolution is used in subsequent calculation of a matching. This is a vertical reference between different levels. If m=0, there is no coarser level and the process, but this exceptional process will be described using FIG. 13.

On the other hand, a horizontal reference within the same level is also performed. As indicated by the equation (20) in [1.3.3], f^{(m,3)}, f^{(m,2)} and f^{(m,1)} are respectively determined so as to be analogous to f^{(m,2)}, f^{(m,1)} and f^{(m,0)}. This is because a situation in which the submappings are totally different seems unnatural even though the type of critical points differs so long as the critical points are originally included in the same source and destination images. As can been seen from the equation (20), the closer the submappings are to each other, the smaller the energy becomes, so that the matching is then considered more satisfactory.

As for f^{(m,0)}, which is to be initially determined, a coarser level by one is referred to since there is no other submapping at the same level to be referred to as shown in the equation (19). In the experiment, however, a procedure is adopted such that after the submappings were obtained up to f^{(m,3)}, f^{(m,0)} is renewed once utilizing the thus obtained submappings as a constraint. This procedure is equivalent to a process in which s=4 is substituted into the equation (20) and f^{(m,4)} is set to f^{(m,0)} anew. The above process is employed to avoid the tendency in which the degree of association between f^{(m,0)} and f^{(m,3)} becomes too low. This scheme actually produced a preferable result. In addition to this scheme, the submappings are shuffled in the experiment as described in [1.7.1], so as to closely maintain the degrees of association among submappings which are originally determined independently for each type of critical point. Furthermore, in order to prevent the tendency of being dependent on the starting point in the process, the location thereof is changed according to the value of s as described in [1.7].

FIG. 13 illustrates how the submapping is determined at the 0-th level. Since at the 0-th level each sub-image is constituted by a single pixel, the four submappings f^{(0,s)} is automatically chosen as the identity mapping. FIG. 14 shows how the submappings are determined at the first level. At the first level, each of the sub-images is constituted of four pixels, which are indicated by a solid line. When a corresponding point (pixel) of the point (pixel) x in p^{(1,s)} is searched within q^{(1,s)}, the following procedure is adopted.

1. An upper left point a, an upper right point b, a lower left point c and a lower right point d with respect to the point x are obtained at the first level of resolution.

2. Pixels to which the points a to d belong at a coarser level by one, i.e., the 0-th level, are searched. In FIG. 14, the points a to d belong to the pixels A to D, respectively. However, the points A to C are virtual pixels which do not exist in reality.

3. The corresponding points A′ to D′ of the pixels A to D, which have already been defined at the 0-th level, are plotted in q^{(1,s)}. The pixels A′ to C′ are virtual pixels and regarded to be located at the same positions as the pixels A to C.

4. The corresponding point a′ to the point a in the pixel A is regarded as being located inside the pixel A′, and the point a′ is plotted. Then, it is assumed that the position occupied by the point a in the pixel A (in this case, positioned at the upper right) is the same as the position occupied by the point a′ in the pixel A′.

5. The corresponding points b′ to d′ are plotted by using the same method as the above 4 so as to produce an inherited quadrilateral defined by the points a′ to d′.

6. The corresponding point x′ of the point x is searched such that the energy becomes minimum in the inherited quadrilateral. Candidate corresponding points x′ may be limited to the pixels, for instance, whose centers are included in the inherited quadrilateral. In the case shown in FIG. 14, the four pixels all become candidates.

The above described is a procedure for determining the corresponding point of a given point x. The same processing is performed on all other points so as to determine the submappings. As the inherited quadrilateral is expected to become deformed at the upper levels (higher than the second level), the pixels A′ to D′ will be positioned apart from one another as shown in FIG. 3.

Once the four submappings at the m-th level are determined in this manner, m is incremented (S22 in FIG. 12). Then, when it is confirmed that m does not exceed n (S23), return to S21. Thereafter, every time the process returns to S21, submappings at a finer level of resolution are obtained until the process finally returns to S21 at which time the mapping f⁽ⁿ⁾ at the n-th level is determined. This mapping is denoted as f⁽ⁿ⁾ (η=0) because it has been determined relative to η=0.

Next, to obtain the mapping with respect to other different η, η is shifted by Δη and m is reset to zero (S24). After confirming that new η does not exceed a predetermined search-stop value ηₘₐₓ (S25), the process returns to S21 and the mapping f⁽ⁿ⁾ (η=Δη) relative to the new η is obtained. This process is repeated while obtaining f⁽ⁿ⁾ (η=iΔη) (i=0, 1, . . . ) at S21. When η exceeds ηₘₐₓ, the process proceeds to S26 and the optimal η=ηₒₚₜ is determined using a method described later, so as to let f⁽ⁿ⁾ (η=ηₒₚₜ) be the final mapping f⁽ⁿ⁾.

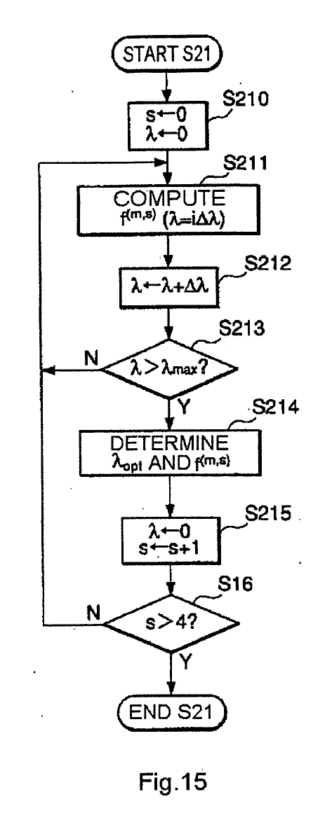

FIG. 15 is a flowchart showing the details of the process of S21 shown in FIG. 12. According to this flowchart, the submappings at the m-th level are determined for a certain predetermined η. When determining the mappings, the optimal λ is defined independently for each submapping in the base technology.

Referring to FIG. 15, s and λ are first reset to zero (S210). Then, obtained is the submapping f^{(m,s)} that minimizes the energy with respect to the then λ (and, implicitly, η) (S211), and the thus obtained is denoted as f^{(m,s)} (λ=0). In order to obtain the mapping with respect to other different λ, λ is shifted by Δλ. After confirming that new λ does not exceed a predetermined search-stop value λₘₐₓ (S213), the process returns to S211 and the mapping f^{(m,s)} (λ=Δλ) relative to the new λ is obtained. This process is repeated while obtaining f^{(m,s)} (λ=iΔλ) (i=0, 1, . . . ). When λ exceeds λₘₐₓ, the process proceeds to S214 and the optimal λ=λₒₚₜ is determined, so as to let f⁽ⁿ⁾ (λ=λₒₚₜ) be the final mapping f^{(m,s)} (S214).

Next, in order to obtain other submappings at the same level, λ is reset to zero and s is incremented (S215). After confirming that s does not exceed 4 (S216), return to S211. When s=4, f^{(m,0)} is renewed utilizing f^{(m,3)} as described above and a submapping at that level is determined.

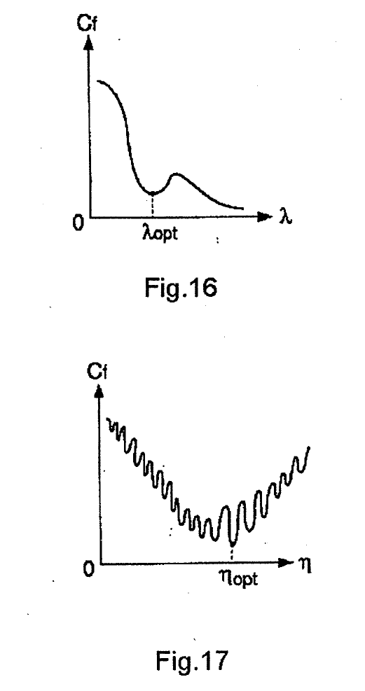

FIG. 16 shows the behavior of the energy C_{f}^{(m,s)} corresponding to f^{(m,s)} (λ=iΔλ) (i=0, 1, . . . ) for a certain m and s while varying λ. Though described in [1.4], as λ increases, C_{f}^{(m,s)} normally decreases but changes to increase after λ exceeds the optimal value. In this base technology, λ in which C_{f}^{(m,s)} becomes the minima is defined as λₒₚₜ. As observed in FIG. 16, even if C_{f}^{(m,s)} turns to decrease again in the range λ>λₒₚₜ, the mapping will be spoiled by then and becomes meaningless. For this reason, it suffices to pay attention to the first occurring minima value. λₒₚₜ is independently determined for each submapping including f⁽ⁿ⁾.

FIG. 17 shows the behavior of the energy C_{f}⁽ⁿ⁾ corresponding to f⁽ⁿ⁾ (η=iΔη) (i=0, 1, . . . ) while varying η. Here too, C_{f}⁽ⁿ⁾ normally decreases as η increases, but C_{f}⁽ⁿ⁾ changes to increase after η exceeds the optimal value. Thus, η in which C_{f}⁽ⁿ⁾ becomes the minima is defined as ηₒₚₜ. FIG. 17 can be considered as an enlarged graph around zero along the horizontal axis shown in FIG. 4. Once ηₒₚₜ is determined, f⁽ⁿ⁾ can be finally determined.

As described above, this base technology provides various merits. First, since there is no need to detect edges, problems in connection with the conventional techniques of the edge detection type are solved. Furthermore, prior knowledge about objects included in an image is not necessitated, thus automatic detection of corresponding points is achieved. Using the critical point filter, it is possible to preserve intensity and locations of critical points even at a coarse level of resolution, thus being extremely advantageous when applied to the object recognition, characteristic extraction, and image matching. As a result, it is possible to construct an image processing system which significantly reduces manual labors.

Some extensions to or modifications of the above-described base technology may be made as follows:

(1) Parameters are automatically determined when the matching is computed between the source and destination hierarchical images in the base technology. This method can be applied not only to the calculation of the matching between the hierarchical images but also to computing the matching between two images in general.

For instance, an energy E₀ relative to a difference in the intensity of pixels and an energy E₁ relative to a positional displacement of pixels between two images may be used as evaluation equations, and a linear sum of these equations, i.e., Eₜₒₜ=αE₀+E₁, may be used as a combined evaluation equation. While paying attention to the neighborhood of the extreme in this combined evaluation equation, α is automatically determined. Namely, mappings which minimize Eₜₒₜ are obtained for various α's. Among such mappings, α at which Eₜₒₜ takes the minimum value is defined as an optimal parameter. The mapping corresponding to this parameter is finally regarded as the optimal mapping between the two images.

Many other methods are available in the course of setting up evaluation equations. For instance, a term which becomes larger as the evaluation result becomes more favorable, such as 1/E₁ and 1/E₂, may be employed. A combined evaluation equation is not necessarily a linear sum, but an n-powered sum (n=2, ½, −1, −2, etc.), a polynomial or an arbitrary function may be employed when appropriate.

The system may employ a single parameter such as the above α, two parameters such as η and λ in the base technology or more than two parameters. When there are more than three parameters used, they are determined while changing one at a time.

(2) In the base technology, a parameter is determined in such a manner that a point at which the evaluation equation C_{f}^{(m,s)} constituting the combined evaluation equation takes the minima is detected after the mapping such that the value of the combined evaluation equation becomes minimum is determined. However, instead of this two-step processing, a parameter may be effectively determined, as the case may be, in a manner such that the minimum value of a combined evaluation equation becomes minimum. In that case, αE₀+βE₁, for instance, may be taken up as the combined evaluation equation, where α+β=1 is imposed as a constraint so as to equally treat each evaluation equation. The essence of automatic determination of a parameter boils down to determining the parameter such that the energy becomes minimum.
(3) In the base technology, four types of submappings related to four types of critical points are generated at each level of resolution. However, one, two, or three types among the four types may be selectively used. For instance, if there exists only one bright point in an image, generation of hierarchical images based solely on f^{(m,3)} related to a maxima point can be effective to a certain degree. In this case, no other submapping is necessary at the same level, thus the amount of computation relative on s is effectively reduced.
(4) In the base technology, as the level of resolution of an image advances by one through a critical point filter, the number of pixels becomes ¼. However, it is possible to suppose that one block consists of 3×3 pixels and critical points are searched in this 3×3 block, then the number of pixels will be 1/9 as the level advances by one.
(5) When the source and the destination images are color images, they are first converted to monochrome images, and the mappings are then computed. The source color images are then transformed by using the mappings thus obtained as a result thereof. As one of other methods, the submappings may be computed regarding each RGB component.

[3] Improvements in the Base Technology

Based on the technology mentioned above, some improvements are made to yield the higher preciseness of matching. Those improvements are thereinafter described.

[3.1] Critical Point Filters and Subimages Considering Color Information

For the effective utilization of the color information in the images, the critical point filters are revised as stated below. First, HIS, which is referred to be closest to human intuition, is introduced as color space, and the formula which is closest to the visual sensitivity of human is applied to the transformation of color into intensity, as follows.

$$H = \frac{\frac{π}{2} - {tan}^{- 1} ( \frac{2 R - G - R}{\sqrt{3 ( G - B )}} )}{2 π} \\ I = \frac{R + G + B}{3} \\ S = 1 - \frac{min ( R , G , B )}{3} \\ Y = 0.299 \times R + 0.587 \times G + 0.114 \times B \qquad ( 53 )$$

Here, the following definition is made, in which the intensity Y and the saturation S at the pixel a are respectively denoted by Y(a) and S(a).

$${α}_{Y} ( a , b ) = \{ \begin{matrix}a Λ & ( Y ( a ) \leq Y ( b ) ) \\ b Λ & ( Y ( a ) > Y ( b ) )\end{matrix} \\ {β}_{Y} ( a , b ) = \{ \begin{matrix}a Λ & ( Y ( a ) \geq Y ( b ) ) \\ b Λ & ( Y ( a ) < Y ( b ) )\end{matrix} \\ {β}_{S} ( a , b ) = \{ \begin{matrix}a Λ & ( S ( a ) \geq S ( b ) ) \\ b Λ & ( S ( a ) < S ( b ) )\end{matrix} \qquad ( 54 )$$

Following five filters are prepared by means of the definition described above.

$${p}_{( i , j )}^{( m , 0 )} = {β}_{Y} ( {β}_{Y} ( {p}_{( 2 i , 2 j )}^{( m + 1 , 0 )} , {p}_{( 2 i , 2 j + 1 )}^{( m + 1 , 0 )} ) , {β}_{Y} ( {p}_{( 2 i + 1 , 2 j )}^{( m + 1 , 0 )} , {p}_{( 2 i + 1 , 2 j + 1 )}^{( m + 1 , 0 )} ) ) \\ {p}_{( i , j )}^{( m , 1 )} = {α}_{Y} ( {β}_{Y} ( {p}_{( 2 i , 2 j )}^{( m + 1 , 1 )} , {p}_{( 2 i , 2 j + 1 )}^{( m + 1 , 1 )} ) , {β}_{Y} ( {p}_{( 2 i + 1 , 2 j )}^{( m + 1 , 1 )} , {p}_{( 2 i + 1 , 2 j + 1 )}^{( m + 1 , 1 )} ) ) \\ {p}_{( i , j )}^{( m , 2 )} = {β}_{Y} ( {α}_{Y} ( {p}_{( 2 i , 2 j )}^{( m + 1 , 2 )} , {p}_{( 2 i , 2 j + 1 )}^{( m + 1 , 2 )} ) , {α}_{Y} ( {p}_{( 2 i + 1 , 2 j )}^{( m + 1 , 2 )} , {p}_{( 2 i + 1 , 2 j + 1 )}^{( m + 1 , 2 )} ) ) \\ {p}_{( i , j )}^{( m , 3 )} = {α}_{Y} ( {α}_{Y} ( {p}_{( 2 i , 2 j )}^{( m + 1 , 3 )} , {p}_{( 2 i , 2 j + 1 )}^{( m + 1 , 3 )} ) , {α}_{Y} ( {p}_{( 2 i + 1 , 2 j )}^{( m + 1 , 3 )} , {p}_{( 2 i + 1 , 2 j + 1 )}^{( m + 1 , 3 )} ) ) \\ {p}_{( i , j )}^{( m , 4 )} = {β}_{S} ( {β}_{S} ( {p}_{( 2 i , 2 j )}^{( m + 1 , 4 )} , {p}_{( 2 i , 2 j + 1 )}^{( m + 1 , 4 )} ) , {β}_{S} ( {p}_{( 2 i + 1 , 2 j )}^{( m + 1 , 4 )} , {p}_{( 2 i + 1 , 2 j + 1 )}^{( m + 1 , 4 )} ) ) \qquad ( 55 )$$

The four filters from the top to the fourth in (55) are almost the same as those in the base technology, and the critical point of intensity is preserved with the color information. The last filter preserves the critical point of saturation, with the color information, too.

At each level of the resolution, five types of subimage are generated by these filters. Note that the subimages at the highest level consist with the original image.

p_{(i,j)}^{(n,0)}=p_{(i,j)}^{(n,1)}=p_{(i,j)}^{(n,2)}=p_{(i,j)}^{(n,3)}=p_{(i,j)}^{(n,4)}=p_{(i,j)} (56)

[3.2] Edge Images and Subimages

By way of the utilization of the information related to intensity derivation (edge) for matching, the edge detection filter by first order derivative is introduced. This filter can be obtained by convolution integral with a given operator H.

p_{(i,j)}^{(n,h)=Y(p}_{(i,j)})\textcircled{×}Hₕ

p_{(i,j)}^{(n,v)}=Y(p_{(i,j)})\textcircled{×}Hᵥ (57)

In this improved base technology, the operator described below is adopted as H, in consideration of the computing speed.

$${H}_{h} = \frac{1}{4} [ \begin{matrix}1 & 0 & - 1 \\ 2 & 0 & - 2 \\ 1 & 0 & - 1\end{matrix} ] \\ {H}_{v} = \frac{1}{4} [ \begin{matrix}1 & 2 & 1 \\ 0 & 0 & 0 \\ - 1 & - 2 & - 1\end{matrix} ] \qquad ( 58 )$$

Next, the image is transformed into the multiresolution hierarchy. Because the image generated by the filter has the intensity of which the center value is 0, the most suitable subimages are the mean value images as follows.

$${p}_{( i , j )}^{( m , h )} = \frac{1}{4} ( {p}_{( 2 i , 2 j )}^{( m + 1 , h )} + {p}_{( 2 i , 2 j + 1 )}^{( m + 1 , h )} + {p}_{( 2 i + 1 , 2 j )}^{( m + 1 , h )} + {p}_{( 2 i + 1 , 2 j + 1 )}^{( m + 1 , h )} ) \\ {p}_{( i , j )}^{( m , v )} = \frac{1}{4} ( {p}_{( 2 i , 2 j )}^{( m + 1 , v )} + {p}_{( 2 i , 2 j + 1 )}^{( m + 1 , v )} + {p}_{( 2 i + 1 , 2 j )}^{( m + 1 , v )} + {p}_{( 2 i + 1 , 2 j + 1 )}^{( m + 1 v )} ) \qquad ( 59 )$$

The images described in (59) are introduced to the energy function for the computing in the “forward stage”, that is, the stage in which an initial submapping is derived, as will hereinafter be described in detail.

The magnitude of the edge, i.e., the absolute value is also necessary for the calculation.

p_{(i,j)}^{(m,e)}={square root over ((p_{(i,j)}^{(n,h)})²+(p_{(i,j)}^{(m,v)})²)} (60)

Because this value is constantly positive, the filter of maximum value is used for the transformation into the multiresolutional hierarchy.

p_{(i,j)}^{(m,e)}=β_{Y}(β_{Y}(p_{(2i,2j)}^{(m+1,e)},p₍₂ᵢ₊₁₎^{(m+1,e)}),β_{Y}(p_{(2i+1,2j)}^{(m+1,e)},p_{(2i+1,2j+1)}^{(m+1,e)})) (61)

The image described in (61) is introduced in the course of determining the order of the calculation in the “forward stage” described later.

[3.3] Computing Procedures

The computing proceeds in order from the subimages with the coarsest resolution. The calculation is performed more than once at each level of the resolution due to the five types of subimages. This is referred to as “turn”, and the maximum number of times is denoted by t. Each turn is constituted with the energy minimization calculations both in the forward stage mentioned above, and the “refinement stage”, that is, the stage in which the submapping is computed again.

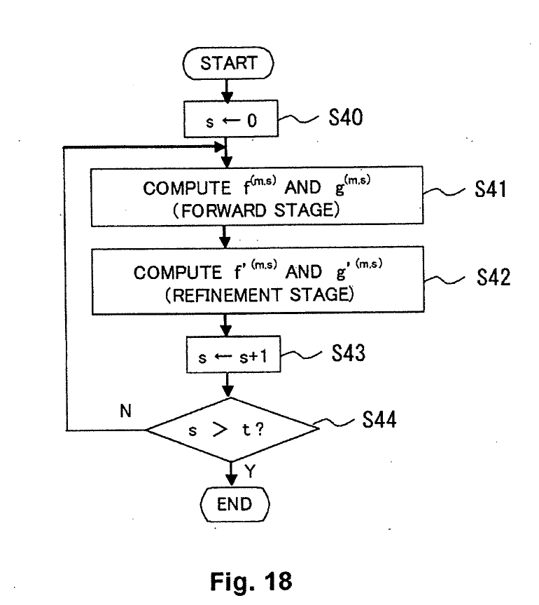

FIG. 18 shows the flowchart related to the improved part of the computing which determines the submapping at the m-th level.

As shown in the figure, s is set to zero (S40) initially. Then the mapping f^{(m,s)} of the source image to the destination image is computed by the energy minimization in the forward stage (S41). The energy minimized here is the linear sum of the energy C, concerning the value of the corresponding pixels, and the energy D, concerning the smoothness of the mapping.

The energy C is constituted with the energy C_{I} concerning the intensity difference, which is the same as the energy C in the base technology shown in [1] and [2], the energy C_{C} concerning the hue and the saturation, and the energy C_{E} concerning the difference of the intensity derivation (edge). These energies are respectively described as follows.

$${C}_{I}^{f} ( i , j ) = {\vert Y ( {p}_{( i , j )}^{( m , σ ( t ) \}} ) - Y ( {q}_{f ( i , j )}^{( m , σ ( t ) )} ) \vert}^{2} \\ {C}_{C}^{f} ( i , j ) = {\vert \begin{matrix}S ( {p}_{( i , j )}^{( m , σ ( t ) )} ) cos ( 2 π H ( {p}_{( i , j )}^{( m , σ ( t ) )} ) ) - \\ S ( {q}_{f ( i , j )}^{( m , σ ( t ) )} ) cos ( 2 π H ( {q}_{f ( i , j )}^{( m , σ ( t ) )} ) )\end{matrix} \vert}^{2} + {\vert \begin{matrix}S ( {p}_{( i , j )}^{( m , σ ( t ) )} ) sin ( 2 π H ( {p}_{( i , j )}^{( m , σ ( t ) )} ) ) - \\ S ( {q}_{f ( i , j )}^{( m , σ ( t ) )} ) sin ( 2 π H ( {q}_{f ( i , j )}^{( m , σ ( t ) )} ) )\end{matrix} \vert}^{2} \\ {C}_{E}^{f} ( i , j ) = {\vert {p}_{( i , j )}^{( m , h )} - {q}_{f ( i , j )}^{( m , h )} \vert}^{2} + {\vert {p}_{( i , j )}^{( m , v )} - {q}_{f ( i , j )}^{( m , v )} \vert}^{2} \qquad ( 62 )$$

The energy D introduced here is the same as that in the base technology before the improvement, shown above. However, in that technology, only the next pixel is taken into account when the energy E₁, which guarantees the smoothness of the images, is derived. On the other hand, the number of the ambient pixels taken into account can be set as a parameter d, in this improved technology.

$${E}_{0}^{f} ( i , j ) = {‖ f ( i , j ) - ( i , j ) ‖}^{2} \\ {E}_{1}^{f} ( i , j ) = {\sum }_{{i}^{′} = i - d}^{i + d} {\sum }_{{j}^{′} = j - d}^{j + d} {‖ \begin{matrix}( f ( i , j ) - ( i , j ) ) - \\ ( f ( {i}^{′} , {j}^{′} ) - ( {i}^{′} , {j}^{′} ) )\end{matrix} ‖}^{2} \qquad ( 63 )$$

In preparation for the next refinement stage, the mapping g^{(m,s)} of the destination image q to the source image p is also computed in this stage.

In the refinement stage (S42), more appropriate mapping f′^{(m,s)} is computed based on the bidirectional mapping, f^{(m,s)} and g^{(m,s)}, which is previously computed in the forward stage. The energy minimization calculation for the energy M, which is defined newly, is performed here. The energy M is constituted with the degree of conformation to the mapping g of the destination image to the source image, M₀, and the difference from the initial mapping, M₁.

M₀^{f′}(i,j)=∥g(f′(i,j))−(i,j)∥²

M₁^{f′}(i,j)=∥f″(i,j)−f(i,j)∥² (64)

The mapping g′^{(m,s)} of the destination image q to the source image p is also computed in the same manner, so as not to distort the symmetry.

Thereafter, s is incremented (S43), and when it is confirmed that s does not exceed t (S44), the computation proceeds to the forward stage in the next turn (S41). In so doing, the energy minimization calculation is performed using a substituted E₀, which is described below.

E₀^{f}(i,j)=∥f(i,j)−f′(i,j)∥² (65)

[3.4] Order of Mapping Calculation

Because the energy concerning the mapping smoothness, E₁, is computed using the mappings of the ambient points, the energy depends on whether those points are previously computed or not. Therefore, the total mapping preciseness significantly changes depending on the point from which the computing starts, and the order. So the image of the absolute value of edge is introduced. Because the edge has a large amount of information, the mapping calculation proceeds from the point at which the absolute value of edge is large. This technique can make the mapping extremely precise, in particular, for binary images and the like.

### EMBODIMENT RELATED TO IMAGE PROCESSING

The base technology enables generation of corresponding point information indicating correspondence between image frames. Accordingly, by using the base technology to obtain corresponding point information indicating correspondence between a source image and a destination image in moving images and by storing the source image and the corresponding point information, high definition moving images can be reproducibly compressed. Experiments have shown that the approach provides both image quality and compression ratio that exceed MPEG.

A case will be considered in which there is an object (hereinafter, referred to as an “occluder”) that moves between two image frames in moving images subject to compression. Comparison between the two image frames reveals that a given area is captured in one of the image frames but is occluded by the object in the other image frame (hereinafter, such an area will be referred to as an occlusion area). This means that pixels included in an occlusion area in one of the image frames do not find a match in the other image frame. As mentioned above, the base technology requires that the bijectivity condition be satisfied. Therefore, the corresponding point information may be inaccurate and may not represent the actual correspondence, if a situation as described above occurs. Accordingly, compression of moving images by using the base technology may result in reduction in the quality with which decoded images are reproduced in an occlusion area.

In this background, the embodiment provides a technology for isolating an occlusion area created by an occluder that moves between image frames. By isolating an occlusion area successfully, there is a chance that the quality with which decoded images are reproduced is improved with the use of a method of compression other than the base technology in the isolated part.

FIG. 19 is a functional block diagram illustrating the structure of an image processing apparatus 10 according to the embodiment. The blocks as shown may be implemented in hardware by elements such as a CPU or a memory of a computer, and in software by a computer program or the like. FIG. 19 depicts functional blocks implemented by cooperation of hardware and software. Therefore, it will be obvious to those skilled in the art that the functional blocks may be implemented in a variety of manners by a combination of hardware and software.

An image reader 12 reads image data captured by, for example, an imaging device and stores the image data in an image storage 14. The number of pixels in moving images captured and the number of frames per second may be as desired. A corresponding point information generator 110 computes matching between two image frames in the image data by using the base technology or another technology, so as to generate a corresponding point information file.

A segmenting unit 120 segments an image frame into a plurality of segments. The segmenting unit 120 includes: a seed segment generator 122 for generating a seed segment that serves as a starting point in segmentation in an image frame; a segment expander 130 for expanding a seed segment; a segment merger 140 for combining small segments; and a segment map output unit 146 for outputting a segment map.

A motion vector processor 150 calculates motion vectors at the pixels in an image frame by referring to a matching result obtained according to the base technology, and improves the accuracy of the vectors. The motion vector processor 150 uses the improved motion vectors to detect an occluder that moves between image frames and generate a mask image to be applied to the image frames. The mask is supplied to the segmenting unit 120 so as to be used in generating a segment map.

A description will now be given of the functional blocks in the segmenting unit 120.

The seed segment generator 122 includes an affine parameter calculator 124, a seed block selector 126 and a seed block growth unit 128. The affine parameter calculator 124 segments each of two image frames, of which one will be referred to as a source image frame and the other as a destination image frame, into a plurality of blocks. The calculator 124 then applies a multiresolutional critical point filter to the blocks. For each block in the source image frame, affine parameters indicating the configuration of the block in the destination image frame are calculated. Given that the position vector in the source image frame (position vector indicating the coordinates before the transformation) is indicated by V, and the position vector in the destination image frame (position vector indicating the coordinates after the transformation) is indicated by V′, V′=αV+β, where α denotes a parameter indicating deformation, zooming and shear of a block, and β denotes a parameter indicating translation.

The seed block selector 126 examines the blocks in an image frame so as to select a seed block that serves as a starting point in generating segments. A block, which is subjected to affine transformation and which is characterized by excellent matching between the pixel values included in that block and the pixel values of the corresponding block in the destination image frame, is selected as a seed block.

The seed block growth unit 128 examines blocks adjacent to the seed block in an affine parameter space, so as to generate a seed segment by combining a seed block with a block characterized by a small error occurring in affine transformation.

The segment expander 130 develops the process of combining the seed segment with blocks, by determining whether a predetermined condition warranting combination is met in the seed segment and adjacent blocks. The segment expander 130 represents a functional block for determining whether a condition warranting combination is met. As such, the expander 130 includes an affine parameter determining unit 132, a pixel value determining unit 134 and an edge degree determining unit 136.

The affine parameter determining unit 132 examines a difference between the affine parameters of the seed segment and the affine parameters of adjacent blocks. The pixel value determining unit 134 examines an error occurring when the affine parameters of the seed segment are applied to the adjacent blocks. The edge degree determining unit 136 determines whether an edge of an occluder is included in the seed segment and the adjacent block.

The segment merger 140 merges initial segments thus generated. Whether a merge should take place is determined by a deviation determining unit 142 and a boundary determining unit 144.

The segment map output unit 146 receives the result of merging segments and outputs a segment map showing an image frame segmented into several segments. The map is used to, for example, improve the precision of matching in the image frame as a whole. In this process, the base technology may be used to obtain corresponding point information for segments not affected by an occluder. For segments where there are actually no frame-to-frame corresponding points, the known block matching algorithm may be used.

A description will now be given of the functional blocks in the motion vector processor 150. The motion vector processor 150 includes a motion vector detector 152, a reliable area isolator 154, a motion vector improving unit 160 and a mask generator 158.

The motion vector detector 152 obtains motion vectors at pixels in image frames, by computing matching between two consecutive image frames by using the base technology. The reliable area isolator 154 segments an image frame into a “reliable area” in which the motion vectors are reliable and a “non-reliable area” in which they are not reliable. A reliable area represents a part dominant in an area in image frame.

The motion vector improving unit 160 expands the reliable area by successively applying motion vectors in the reliable area to pixels in the non-reliable area and seeing if a highly precise result is obtained. The motion vector improving unit 160 includes a layer setting unit 162, a difference determining unit 164, a layer applying unit 166 and a block matching unit 168.

The layer setting unit 162 sets up a layer at the boundary between the reliable area and the non-reliable area. The difference determining unit 164 determines whether the layer thus set up can be incorporated in the reliable area. The layer applying unit 166 substitutes the motion vector in the reliable area for the motion vector originally occurring in the layer, when it is determined that the layer can be incorporated into the reliable area. The block matching unit 168 searches for more reliable motion vectors by performing block matching according to the related art in the remaining non-reliable area.

An occlusion detector 156 uses the improved motion vectors to detect an occlusion area in an image frame affected by an occluder.

A mask generator 158 generates a mask for causing the pixels included in the occlusion area to remain and for removing the other parts. The mask is delivered to the segment expander 130 and is used to determine whether to combine the segment and the adjacent blocks.

FIG. 20 is a flowchart showing a schematic operation according to the embodiment. First, the corresponding point information generator 110 applies the base technology to a source image frame and a destination image frame extracted from image data so as to obtain corresponding point information (S100). The motion vector processor 150 refers to the corresponding point information thus obtained so as to calculate, for each pixel, a motion vector between the source image frame and the destination image frame. The processor 150 repeats the process described later so as to improve the accuracy of the motion vectors in the image frames (S102). The motion vector processor 150 identifies an occlusion area in the image frames by using the improved motion vectors and generates a mask for causing the pixels in the occlusion area to remain (S104).

Apart from the process of generating a mask, the segmenting unit 120 uses the corresponding point information obtained in S100 so as to generate, in an image frame, a seed segment, which serves as a starting point in segmenting the image frame into a plurality of areas (S106). The segmenting unit 120 expands the area of the seed segment by repeatedly determining whether a block surrounding the seed segment can be combined with the seed segment (S108). The segmenting unit 120 repeatedly determines whether a plurality of seed segments thus generated should be merged (S110). Ultimately, the unit 120 outputs a segment map showing an image frame segmented into several segments (S112).

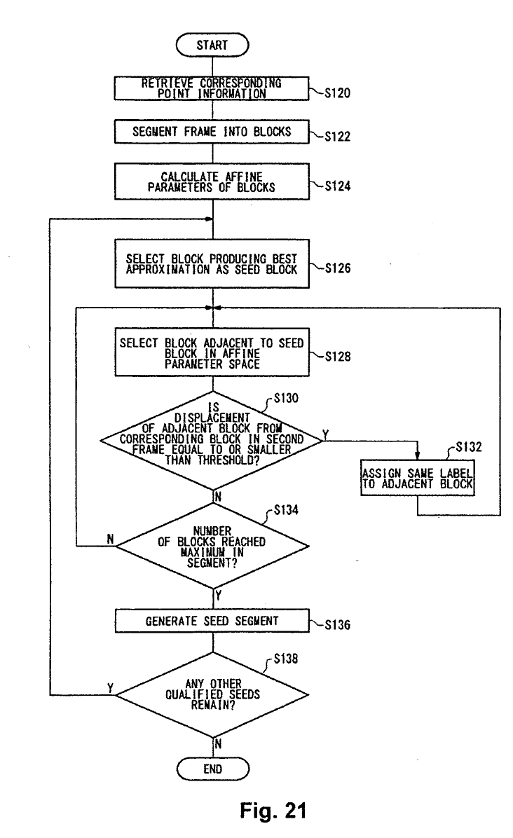

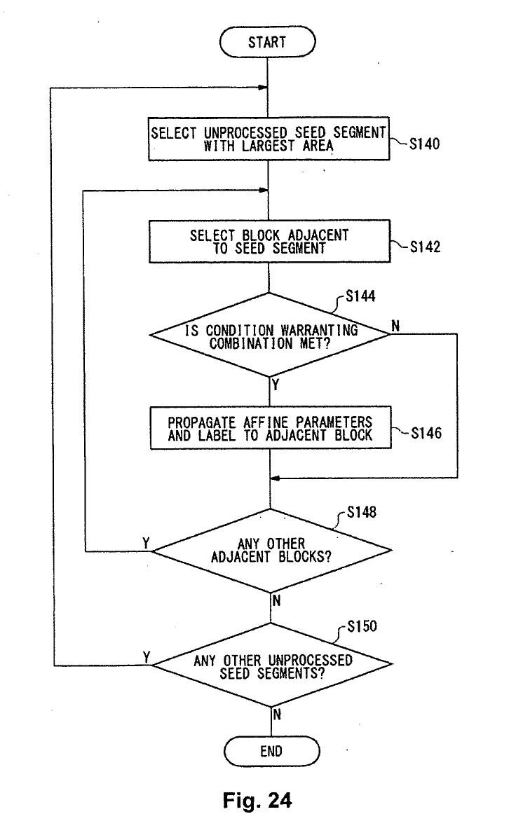

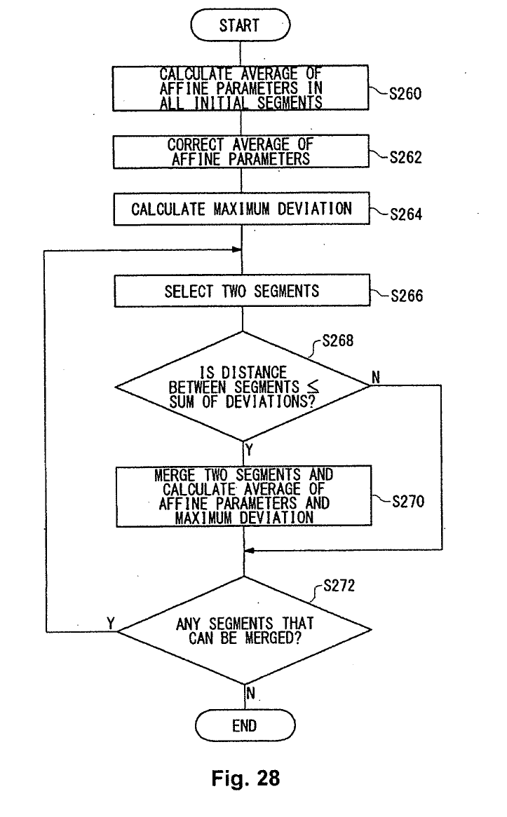

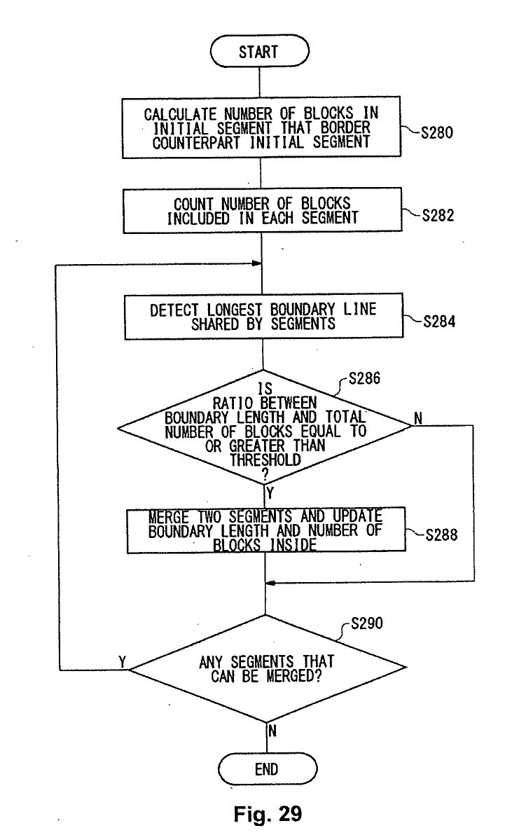

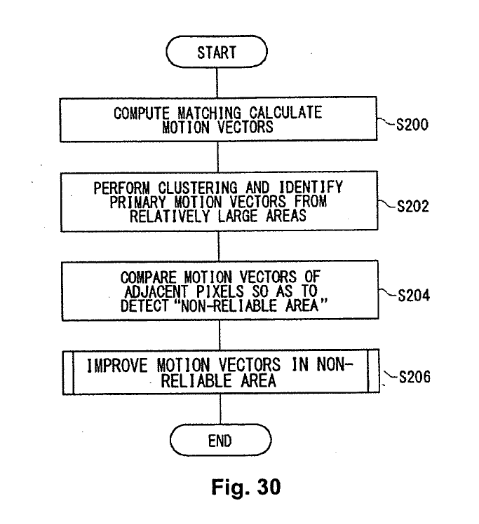

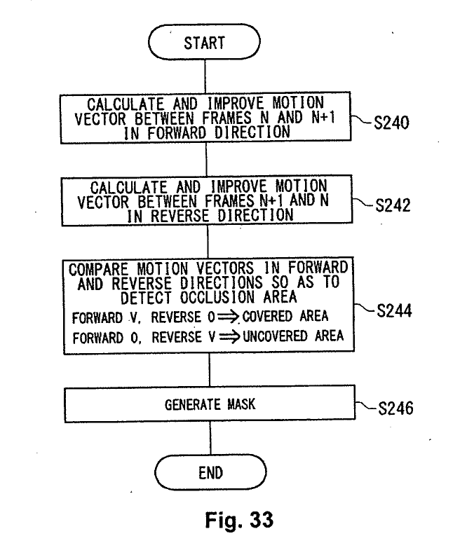

Referring to FIG. 20, step S102 corresponds to FIG. 30, step S104 corresponds to FIG. 33, step S106 corresponds to FIG. 21, step S108 corresponds to FIGS. 24, 25 and 26, and step S110 corresponds to FIGS. 28 and 29. The details of the steps are described with reference to the corresponding figures.

FIG. 21 is a flowchart showing the detail of step S106 for generating a seed segment.

The seed segment generator 122 retrieves corresponding point information from the corresponding point information generator 110 (S120). The affine parameter calculator 124 then segments a source image frame into a plurality of equally-sized blocks (e.g., 2×2 pixels) (S122). The calculator 124 calculates affine parameters indicating where, in a destination image frame, each block in a source image frame is mapped, by referring to the result of extracting critical points (S124). Instead of using the base technology, affine parameters may be calculated by using the optical flow estimated between the source image frame and destination image frame. Using the base technology will generally yield more precise affine parameters.

Subsequently, the seed block selector 126 examines the blocks for which affine parameters are calculated and selects a block for which the affine parameters give the best approximation. The selector 126 determines the selected block as a seed block which serves as a starting point in generating seed segments (S126). Approximation may be determined by examining a sum of potential energy and pixel difference energy of pixels constituting a block and pixels in the destination of movement represented by the affine parameters. The block which gives the smallest sum of energy will be determined as a seed block. A moving image frame captured in an ordinary fashion will only include not more than several seed blocks.

Subsequently, the seed block-growth unit 128 selects another block adjacent to the seed block (S128). The seed block growth unit 128 examines the adjacent block to determine whether a difference in distance between pixels in a block, which is subjected to affine transformation, and pixels in a corresponding block in a destination image frame is equal to or smaller than a threshold (S130). When the difference is equal to or smaller than a threshold (Y in S130), the seed block growth unit 128 assigns to the adjacent block the same label as assigned to the seed block (S132), whereupon the process is returned to S128. Each block is assigned one label. Blocks with the same label are associated with the same affine parameters. That is, when the displacement determined for the adjacent block in a destination image frame is equal to or smaller than a threshold, the adjacent block is regarded as a part characterized by the same movement as the seed block and is therefore assigned the same label as the seed block.

If the displacement determined for the adjacent block in a destination image frame is greater than the threshold (N in S130), the seed block growth unit 128 determines that the adjacent block is a part characterized by a movement different from that of the seed block. The unit 128 assigns a different label to that block. The seed block growth unit 128 determines whether the number of blocks assigned the same label as the seed block has reached a predetermined upper limit in the number of blocks in a segment (S134). When the number of blocks has not reached the upper limit (N in S134), the seed block growth unit 128 selects another block adjacent to the seed block (S128) and repeats the steps S130 and S132. When the number of blocks has reached the upper limit (Y in S134), the seed block growth unit 128 generates a seed segment which includes all of the blocks assigned the same label as the seed block (S136). The seed block growth unit 128 determines whether any other seed blocks remain in the image frame (S138). When there are any other seed blocks (Y in S138), the unit 128 repeats the steps S128-S136 for the blocks adjacent to the seed blocks. When there are no other seed blocks left (N in S138), the flow is terminated.

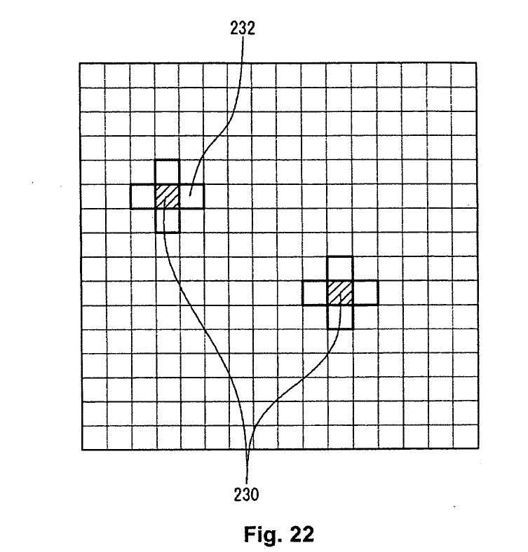

FIG. 22 shows how an image frame is divided into a plurality of equally-shaped blocks by the seed segment generator 122. Referring to FIG. 22, assuming that solid blocks 230 are determined as seed blocks by the seed block selector 126, a blank block 232 represents an adjacent block.

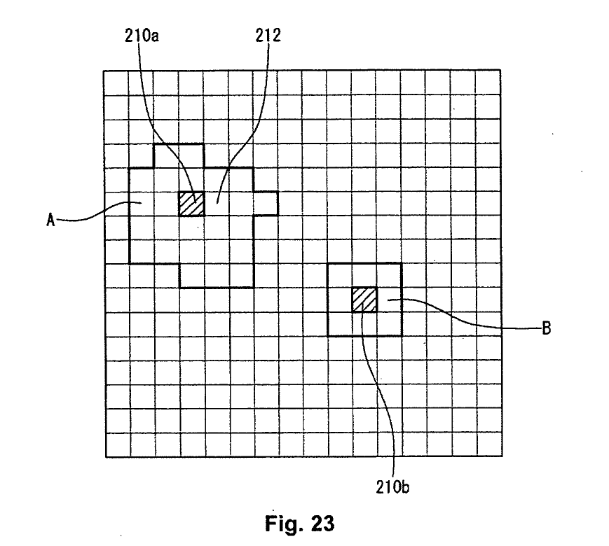

FIG. 23 shows how adjacent blocks are assigned the same label as the seed block. Adjacent blocks surrounding seed blocks 210a and 210b are incorporated into the respective seed segments and are assigned the same label as the seed segment. Ultimately, blocks assigned the same label constitute a seed segment. FIG. 23 shows how a seed segment A is generated starting from the seed block 210a and a seed segment B is generated starting from the seed block 210b.

When the process shown in FIG. 21 is completed for all of the seed blocks in the source image frame, the image frame will be segmented into one or a plurality of seed segments, which is built around the seed block and in which the affine parameters of the seed block are propagated to the surrounding blocks, and the other parts.

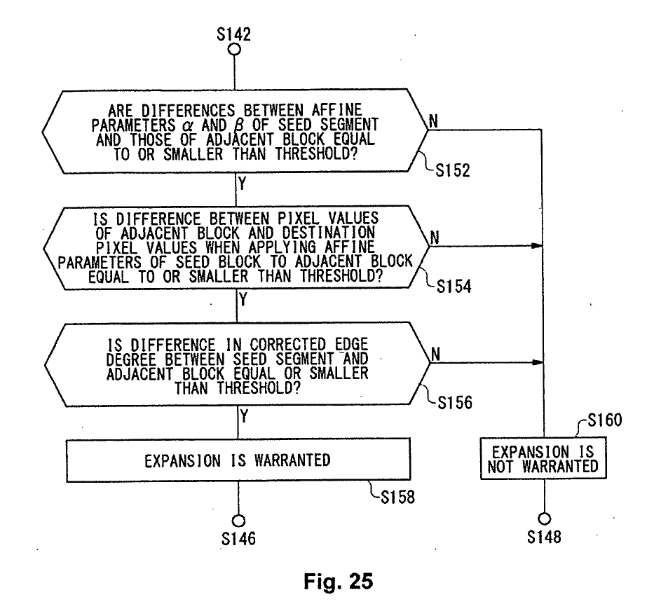

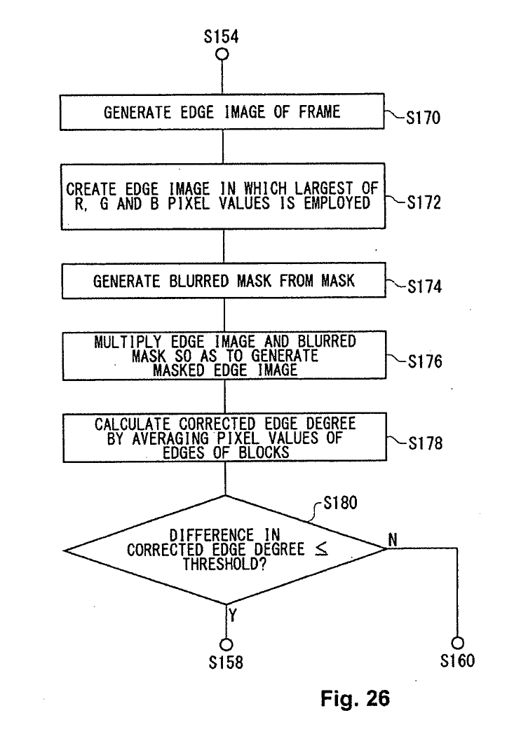

FIG. 24 is a flowchart showing the detail of step S108 for expanding a seed segment area. The segment expander 130 receives seed segments from the seed segment generator 122 and selects, from the plurality of seed segments, the one with the largest area (S140). Subsequently, the expander 130 examines the blocks adjacent to the selected seed segment so as to select a block not belonging to any of the other seed segments (S142). A determination is then made as to whether the selected block and the seed segment meet a predetermined condition warranting combination (S144). The determination is made by the affine parameter determining unit 132, the pixel determining unit 134 and the edge determining unit 136. The details of the condition warranting combination and the process of determination will be described later with reference to FIGS. 25 and 26.

When the condition warranting combination is met in its entirety (Y in S144), the segment expander 130 assigns the affine parameters and the label of the seed block to the selected block (S146). When the condition warranting combination is not met (N in S144), step S146 is skipped. Subsequently, the segment expander 130 examines the blocks adjacent to the seed segment to determine whether there are any blocks yet to be subjected to the determination (S148). When there are any adjacent blocks yet to be subject to the determination (Y in S148), the steps S142 through S146 are repeated for the blocks. When there are no blocks yet to be subjected to the determination (N in S148), a determination is made as to whether there are any other seed segments for which the above process is not completed (S150). When there are any seed segments not processed (Y in S150), the steps S142 through S148 are repeated for the remaining seed segments. When no seed segments remain unprocessed (N in S150), the flow is terminated.

The blocks once incorporated into a seed segment subsequently form a part of the seed segment. The above steps are repeated for the newly incorporated block and the adjacent blocks.

The process of FIG. 24 is for incorporating into the seed segment those of the adjacent blocks, not incorporated into the seed segment through the process of FIG. 21, that meet the predetermined condition warranting combination. One or a plurality of seed segments obtained through the process of FIG. 24 will hereinafter be referred to as “initial segments”. Subsequently, the segment merger 140 determines whether to merge initial segments.

FIG. 25 is a flowchart showing the detail of step S144 of FIG. 22 for determining the condition warranting combination.

The affine parameter determining unit 132 selects one of the blocks adjacent to a seed segment so as to determine whether differences between the affine parameters α and β of the selected block and the affine parameters α and β of the seed segment are equal to or smaller than a predetermined threshold (S152). When the differences are equal to or smaller than the threshold (Y in S152), the unit 132 experimentally applies the affine parameters of the seed segment to the adjacent block. The pixel determining unit 134 compares an average of pixel values of a block which is a target of affine transformation and an average of pixel values of the corresponding block, and determines whether the difference is equal to or smaller than a predetermined threshold (S154). Even when a seed segment and an adjacent block are close to each other in the affine parameter space, i.e., even when the affine parameters of a seed segment and those of an adjacent block approximate each other, their mapping targets may be to tally different if the seed segment or the adjacent block moves across a boundary between image frames in moving from the source image frame to the destination image frame. For this reason, an accurate determination as to whether the adjacent block should be incorporated into the seed segment is made by verifying the pixel values of the destination of movement of the adjacent block occurring when the same affine parameters as the seed block are assigned to the adjacent block.

For the thresholds in S152 and S154, values that will produce proper results are experimentally determined by attempting image processing according to the embodiment a plurality of times.

When the difference between the averages of the pixel values is equal to smaller than the threshold (Y in S154), the edge degree determining unit 136 determines whether a difference in a “corrected edge degree” calculated for the seed segment and the adjacent block is equal to or smaller that a threshold (S156). The corrected edge degree is an indicator indicating the occupancy of edges, detected in the image frame, within the seed segment and the adjacent block. The method of calculating the corrected edge degree will be described later. The large difference in the corrected edge degree means that it is highly likely that the adjacent block includes edges of the seed segment, i.e., that the adjacent block is located at the edge of the seed segment. In this respect, expansion of the seed segment to the adjacent block is warranted (S158) only when the difference in the corrected edge degree is equal to smaller than a threshold (Y in S156). The flow continues to S146 of FIG. 24.

When any of the three conditions fails to be met (N in S150, N in S152, N in S154), expansion of an area is not warranted (S160), and the flow continues to S148 of FIG. 24.

FIG. 26 is a flowchart showing a method of calculating a corrected edge degree used in the determination in S156.

First, the edge determining unit 136 generates an edge image of an image frame (S170). An edge image may be generated by using a known Sobel filter or other filters. An edge image may be generated for a monochromized image frame. Alternatively, edge images in R, G and B formats may be generated by applying a filter to the R, G, B components of an image frame. Hereafter, it will be assumed that edge images in the R, G and B formats are generated.

The edge degree determining unit 136 compares pixel by pixel the RGB pixel values of three edge images in the R, G and B formats. An image is created in which the largest of the pixel values is employed as a pixel value of each pixel position (hereinafter, such an image will be referred to as a “maximum edge image”) (S172). That is, given that the pixel values at a given position in R, G and B edge images are indicated by ER, EG and EB, respectively, the pixel value at that position will be denoted as max(ER, EG, EB). Thus, generating R, G and B edge images and then generating a single maximum edge image result in an edge image in which the edges are clearly presented. The maximum edge image may be normalized by the maximum value of the pixel values. When an edge image is in monochrome, the above steps are not necessary.

Subsequently, the edge degree determining unit 136 receives a mask from the mask generator 158 and generates a “blurred mask” in which the periphery of the mask is blurred (S174). The detail of mask generation by the mask generator 158 will be described later with reference to FIG. 33. A blurred mask is generated as described below. That is, coefficients in 256 grades are assigned to the pixels within the mask. The coefficients are largest at the center of the mask and approach 0 toward the periphery of the mask. The coefficients outside the mask are 0.

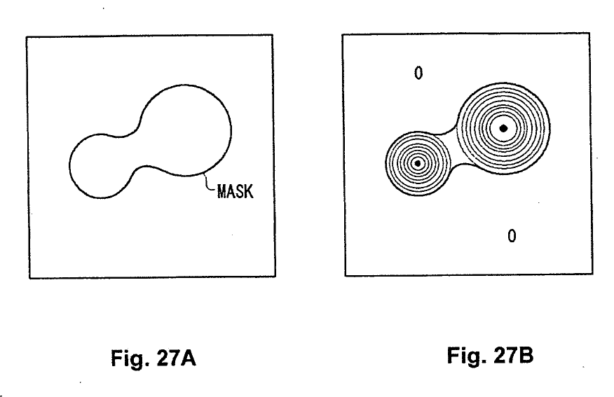

FIGS. 27A and 27B show a relation between a mask and a blurred mask. Given that a mask as shown in FIG. 27A is received from the mask generator 158, a blurred mask will be as shown in FIG. 27B. Referring to FIG. 27B, darker shades within the mask indicate that the coefficients are closer to “1” and lighter shades indicate that the coefficients are closer to “0”. Outside the mask, the coefficients are “0”.

Referring back to FIG. 26, it is ensured that the blurred mask has the same size as the image frame and is then applied to the maximum edge image mentioned above. That is, the coefficients assigned to the respective pixel positions in the blurred mask are multiplied by the pixel values at the corresponding positions in the maximum edge image (S176). As a result, of the edges included in the maximum edge image, only those multiplied by non-zero coefficients within the mask are allowed to remain in the image, and edges multiplied by zero coefficients outside the mask are removed from the image. Hereinafter, the image to which the blurred mask is applied will be referred to as a “masked edge image”.

As described later, the mask generated by the mask generator 158 corresponds to an area swept by an occluder between a source image frame and a destination image frame. Accordingly, only those edges included in an area in which an occluder moves are extracted by applying a blurred mask to a maximum edge image. In other words, only those edges occluded by an occluder in an image frame or edges that show themselves from behind the occluder are extracted.

In generating a blurred mask, the size of a mask received from the mask generator 158 may be slightly enlarged or reduced. Alternatively, instead of generating a blurred mask from a mask, a binary mask, in which the coefficients are 1 within the mask and 0 outside the mask, may be generated and multiplied by a maximum edge image.

The edge degree determining unit 136 uses the masked edge image so as to retrieve the pixel values of edges included in a seed segment and those included in an adjacent block. The unit 136 calculates an average of the pixel values of the edges included in the seed segment and an average of the pixel values of the edges included in the adjacent block (S178). The average of the pixel values of edges represents “corrected edge degree” mentioned above. The edge determining unit 136 calculates a difference between the corrected edge degree in the seed segment and that of the adjacent block, and determines whether the difference is equal to or smaller than a predetermined threshold (S180). For this threshold, a value that will produce a proper result is experimentally determined by attempting image processing according to the embodiment a plurality of times. When the difference is equal to or smaller than the threshold (Y in S158), the adjacent block is incorporated into the seed segment (S158). When the difference exceeds the threshold (N in S158), the adjacent block is not incorporated into the seed segment (S160).

A description will now be given of the physical meaning of the determination as to whether the area of a seed segment should be expanded to an adjacent block by using the corrected edge degree.

The physical meaning of applying a blurred mask to a maximum edge image is as described below. A boundary should be provided only around an occluder in a segment map to be ultimately obtained. For a plurality of still objects in an image other than the occluder, the base technology provides highly precise matching. Therefore, there is no need to consider edges bordering the other objects.

Filters like a Sobel filter detect an edge by looking for a change between adjacent pixels in an image frame. As such, these filters detect boundaries between all objects as edges, irrespective of whether the object moves or is stationary. Thus, in order to ensure that only the edges of an occluder are referred to in determining whether a seed segment should be expanded, a mask is introduced so that unnecessary edges (i.e., edges of stationary objects) are removed.

The reason that the corrected edge degree is compared with the threshold to determine whether the adjacent block should be incorporated into the seed segment is to prevent the seed segment from expanding beyond the boundary of the occluder. As mentioned above, the corrected edge degree is determined only for the edges of the occluder. Therefore, the fact that the difference in corrected edge degree is large means that there is a boundary of an occluder between the seed segment and the adjacent block. In other words, the determination described above is for ensuring that the growth of the area of the seed segment is halted where the corrected edge degree changes dramatically.

A description will now be given of the process of merging a plurality of initial segments generated in the process of FIG. 22. The process is performed in order to remove islands of minute initial segments that remain in an image frame.

FIG. 28 is a flowchart showing a first process of merging initial segments.

The deviation determining unit 142 in the segment merger 140 calculates an average of the affine parameters of the blocks included in each of the initial segments (S260). Subsequently, the merger 140 corrects the average of the affine parameters so that an error, from the pixel values of the blocks in the source image frame occurring when the average of the affine parameters is applied to the blocks in the initial segments in the destination image frame, is minimized (S262). Further, the unit 142 calculates a maximum distance (hereinafter, referred to as deviation) from the average of the affine parameters in the initial segment (S264).

After executing the above steps for all initial segments, two initial segments subject to a determination on merge are selected (S266). A determination is then made as to whether a distance “d” between the centers of the two initial segments in the affine parameter space is equal to or smaller than a sum of deviations of the two initial segments (S268). A mathematical representation for the two segments A and B will be as follows.

d≦ra+rb (66)

where d denotes a distance between the centers of the initial segment A and the initial segment B, ra denotes a maximum deviation of the initial segment A and rb denotes a maximum deviation of the initial segment B.

When it is determined in S268 that the equation (66) holds (Y in S268), the two initial segments selected are merged so as to generate a new segment. An average of the affine parameters of the initial segment thus generated and a deviation from the average are calculated (S270). When the equation (66) does not hold (N in S268), the two initial segments selected are not merged. The deviation determining unit 142 determines whether there remain any pairs of initial segments that are not subjected to the determination of S268 (S272). When any pairs of initial segments remain (Y in S272), step S266 and the subsequent steps are repeated. When no pairs of initial segments remain (N in S272), the flow is terminated.

The process shown in FIG. 28 is for determining whether the two initial segments circumscribe each other in the affine parameter space. When the segments circumscribe each other, they are considered as a single segment.

FIG. 29 is a flowchart showing a second process of merging initial segments.

The boundary determining unit 144 finds a pair of initial segment that border each other and counts the number of blocks in each segment that border the counterpart initial segment (S280). Subsequently, the unit 144 counts the total number “b” of blocks included in each initial segment (S282). Further, of the boundary lines shared by the initial segments, the unit 144 detects the longest boundary line and determines its length “l” (S284).

The boundary determining unit 144 determines whether the ratio l/b between the length “l” and the total number of blocks “b” is equal to or greater than a predetermined threshold (S286). If the ratio is equal to or greater than the threshold (Y in S286), the unit 144 merges the two initial segments so as to create a new segment, and calculates the total number of blocks inside the new segment (S288). If the ratio is less than the threshold (N in S286), the initial segments are not merged. The boundary determining unit 144 determines whether any pairs of initial segments remain which are not subjected to determination of S286 yet (S290). If any pairs of initial segments remain (Y in S290), step S284 and the subsequent steps are repeated. If no pairs of initial segments remain (N in S290), the flow is terminated.

Thus, by performing a series of processes, the initial segments are combined to form one or a plurality of segments ultimately. The segments are for differentiating between an area swept by an occluder and the remaining background area. The segment map outputting unit 146 outputs a segment map showing the boundaries between the segments. The segment map may be used in various image processes. For example, parts between the segments defined in a segment map are parts where the base technology does not necessarily produce accurate matching. Therefore, high-precision image compression is achieved by using the related-art block matching technology in the above-mentioned parts to generate a predictive image, and by using the base technology in the other parts to generate a predictive image.

FIG. 30 is a flowchart showing the detail of step S102 of FIG. 20 for improving a motion vector.

Firstly, the motion vector detector 152 receives corresponding point information indicating correspondence between a source image frame and a destination image frame from the corresponding point information generator 110. The detector 152 refers to the information so as to calculate motion vectors at the pixels of the frames (S200). Instead of using the base technology, motion vectors may be calculated by using an optical flow algorithm according to the related art.

Subsequently, the reliable area isolator 154 performs clustering of the motion vectors so as to identify areas having the same motion vectors in the image frame. Of these areas, the isolator 154 selects a relatively large area (S202). The motion vector in the selected area will be referred to as a “primary motion vector” in the image frame. In moving images captured in an ordinary fashion, the number of primary motion vectors detected in an image frame is two at most. One of the primary motion vectors is the motion vector of the background area. The size of the motion vector is approximately 0.

Subsequently, the reliable area isolator 154 isolates a “reliable area”, where the accuracy of motion vectors is relatively high, from a “non-reliable area”, where the accuracy of motion vectors is relatively low (S204). The categorization is performed by comparing a difference in motion vectors between adjacent pixels and a predetermined threshold. Given that motion vectors at a pixel (x1, y1) and an adjacent pixel (x2, y2) are denoted by motion( ), a difference D in motion vectors will be defined as follows.

D=|motion(x1,y1)−motion(x2,y2)|/max(|motion(x1,y1)|,|motion(x2,y2)|) (67)

The equation (67) indicates that the absolute value of the difference in motion vectors between the two pixels is divided by the larger of the motion vector for normalization.

A difference in motion vectors at two pixels will be very small if the two pixels belong to the same object. Thus, if the difference D is greater than a threshold, it is highly likely that one of the pixels is included in an occluder. It is doubtful whether the motion vector is accurate so that these pixels are categorized as belonging to the non-reliable area. If the difference D is equal to or smaller than the threshold, the pixels are categorized as belonging to the reliable area. With this categorization, an occluder in the image frame is detected in a coarse manner.

The motion vector improving unit 160 improves the motion vectors in the non-reliable area on a pixel basis by using, for example, the primary motion vector in the reliable area (S206).

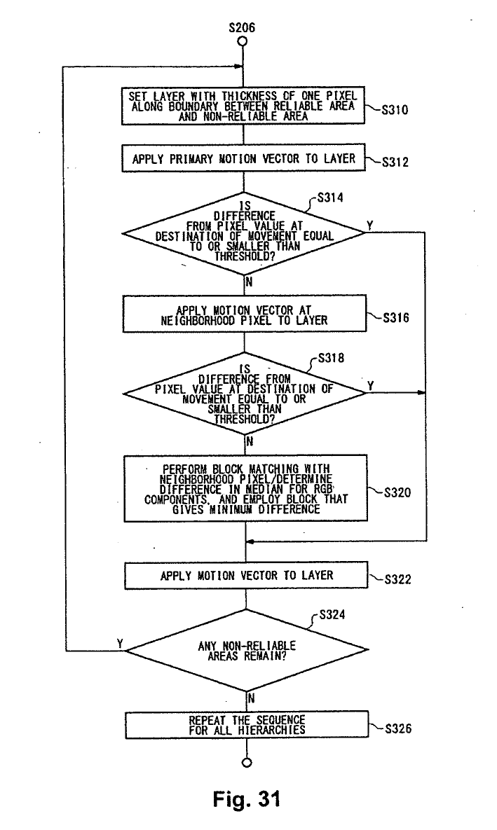

FIG. 31 is a flowchart showing the detail of step S206 for improving a motion vector.

Firstly, the layer setting unit 162 defines a layer with a thickness of one pixel along the boundary between the reliable area and the non-reliable area (S310).

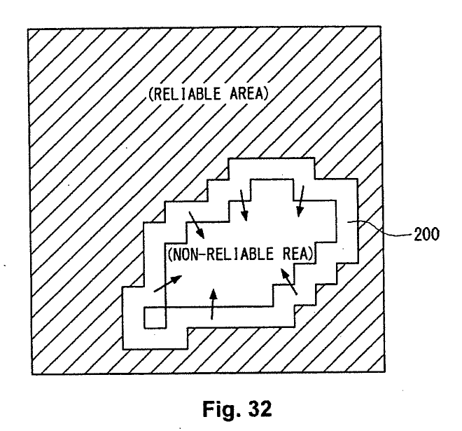

FIG. 32 schematically shows a layer. Referring to FIG. 32, a hatched part represents a reliable area, and a blank area represents a non-reliable area. A layer 200 with a thickness of one pixel is defined outside the reliable area and along the boundary between the reliable area and the non-reliable area. By successively defining new layers with one pixel width outside the layer, the reliable area is gradually expanded into the non-reliable area.

Referring back to FIG. 31, the difference determining unit 164 applies the primary motion vector in the reliable area to the layer currently set up (S312). The target position of movement in the destination image frame, occurring when the primary motion vector is hypothetically assigned to the pixels constituting the layer, is examined. When there are two or more primary motion vectors in the image frame, the primary motion vector with the smallest distance from the layer is applied first, followed by the other primary motion vectors. The difference determining unit 164 calculates a difference between the pixel value at the destination of movement occurring when the motion vector is applied to the pixels in the layer, and the pixel value of the corresponding pixel in the destination image frame. The unit 164 determines whether the difference is equal to or smaller than a threshold value (S314). Errors in RGB pixel values may be calculated so that a sum of squared errors may be defined as a difference. The difference may be defined in other ways. Since a layer is formed of a plurality of pixels, an average of the differences may be determined for all pixels in the layer so as to determine whether the average is equal to or smaller than a threshold.

When the difference is equal to or smaller than the threshold (N in S314), it means that no serious error occurs if the primary motion vector of the reliable area is applied to the layer currently set up. In this case, the layer applying unit 166 substitutes the primary motion vector applied to the layer for the motion vector at the pixels in the layer (S322). When the difference is greater than the threshold (Y in S314), the difference determining unit 164 attempts to apply a motion vector other than the primary motion vector to the layer. For example, the motion vector at a pixel in the neighborhood of the layer in the reliable area is applied to the pixels in the layer (S316). The difference determining unit 164 calculates a difference between the pixel value at the destination of movement defined by the motion vector and the pixel value of the corresponding pixel in the destination image frame, so as to determine whether the difference is equal to or smaller than a threshold (S318). When the difference is equal to or smaller than the threshold (Y in S318), the layer applying unit 166 substitutes the motion vector applied to the layer for the motion vector at the pixel in the layer (S322).

When the difference is larger than the threshold (N in S318), the block matching unit 168 creates a block of 2×2 pixels in the non-reliable area and exhaustively searches for an approximating block in the destination image frame by block matching (S320). The unit 168 determines, for each of the RGB components, a difference between the pixel value of the block identified by the search and the pixel value of the current block. The unit 168 employs a block that gives the minimum difference. The layer applying unit 166 substitutes the motion vector obtained as a result of block matching for the motion vector at the pixel in the layer (S322).

The motion vector improving unit 160 determines whether any non-reliable areas remain in the image frame (S324). When any non-reliable areas remain (Y in S324), S310 and the subsequent steps are repeated. When no non-reliable areas remain (N in S324), the process is terminated in the current hierarchy. The aforementioned sequence of steps is repeated for all hierarchies in the image frame (S326).

Thus, the primary motion vector or the motion vector at an adjacent pixel is applied to each of the pixels included in the non-reliable area so as to see if the application yields a favorable result, i.e., if the application results in a smaller difference from the pixel value at the destination of movement than when the original motion vector is applied. When a favorable result is obtained, the original vector is replaced by the motion vector currently applied. When the result is unfavorable, the motion vector in the non-reliable area is improved by performing block matching for exhaustively searching for a block that gives the smallest difference in the pixel values.

The primary motion vector is applied to the layer for the following reason. As described above, calculating a motion vector by using corresponding point information generated according to the base technology might produce inaccurate motion vectors at a boundary between an occluder and the other parts, because there are no corresponding points in a source image frame and a destination image frame. The embodiment addresses this by calculating a difference D according to the equation (67) so as to roughly isolate a reliable area from a non-reliable area according to the magnitude of the difference D. Subsequently, steps are performed to define more accurate motion vectors within the non-reliable area. In other words, as described above, the primary motion vector in the image frame or the motion vector at the neighborhood pixel in the reliable area is applied one by one so as to identify a more accurate motion vector on a trial and error basis.

In determining an error between blocks by block matching, it is generally more preferably to use Median Absolute Difference instead of Mean Absolute Difference, which is generally more frequently used. Determination by using Mean Absolute Difference offers high speed and easy to implement but is less tolerant to noise. For this reason, the method is not suitable for detection of an occluder because of a large error occurring at the boundary and the tendency for a matching result to be affected by the background. By using Median Absolute Difference, a more proper matching result can be obtained in the neighborhood of the edges of an occluder moving between image frames than by using Mean Absolute Difference. Determination using Median Absolute Difference has a disadvantage of low processing speed since it requires finding a median across the whole data and necessitates block sorting. The process can be made faster, however, by using packet sorting.

Block matching of motion vectors is performed for all hierarchized images from a source image frame and a destination image frame. Block sizes are defined so as to be proportionate to the size of an image frame. Such definition is normally employed in hierarchical block matching. As mentioned before, block matching need not be applied to the entirety of pixels within an image frame but need only be applied to the pixels included in a non-reliable area.

Block matching is as practiced in the related art. In this embodiment, however, the non-reliable area subject to matching is considerably limited in scale by going through the process of applying the primary motion vector or the motion vector in the reliable area to the layer. Therefore, more proper matching result is expected than by looking for a match in the entirety of the image frame. For high-resolution hierarchies, the motion vector in the non-reliable area may be improved without applying a layer and only by using block matching.

Through the process as described above, the accuracy of motion vectors can be improved over the entirety of an image frame. Subsequently, an occlusion area is detected by using the improved motion vectors.

FIG. 33 is a flowchart showing the detail of step S104 of FIG. 20 for generating a mask.

The motion vector improving unit 160 calculates motion vectors between a source image frame N and a destination image frame N+1 in the forward direction and improves the accuracy of the motion vector, in accordance with the process described above (S240). The motion vector improving unit 160 also calculates a motion vector between the destination image frame N+1 and the source image frame N in the reverse direction and improves the accuracy of the motion vector, in accordance with the process described above (S242).

Once the motion vectors in the two directions are obtained, the occlusion detector 156 compares the motion vector in the forward direction with the motion vector in the reverse direction so as to detect an occlusion area, which is an area hidden by an occluder moving between image frames (S244). The detection is based on the following principle. The corresponding point information obtained by using the base technology associates pixels in a source image frame with those in a destination image frame by assuming bijectivity, and so the motion vector in the forward direction and that of the reverse direction will have the same size but lie in opposite directions. Accordingly, pixels, for which the motion vectors have different sizes in the forward direction and in the reverse direction, can be determined as pixels for which accurate corresponding point information is not obtained by the base technology due to an occluder.

It will be understood that there are two types of occlusion areas occluded by an occluder. Firstly, an area may be observed in a source image frame, but is hidden behind an occluder and not observed in a destination image frame (hereinafter, such an area will be referred to as a “covered area”). Secondly, an area may be hidden behind an occluder and not observed in a source image frame, but is observed in a destination image frame as a result of the occluder moving (hereinafter, such an area will be referred to as an “uncovered area”). The areas can be differentiated by comparing a motion vector in the forward direction and a motion vector in the reverse direction. More specifically, pixels characterized by a motion vector with the size v, where v denotes an arbitrary value, in the forward direction and a motion vector with the size 0 in the reverse direction are pixels included in a covered-area. Conversely, pixels characterized by a motion vector with the size 0 in the forward direction and a motion vector with the size v in the reverse direction are pixels included in an uncovered area.

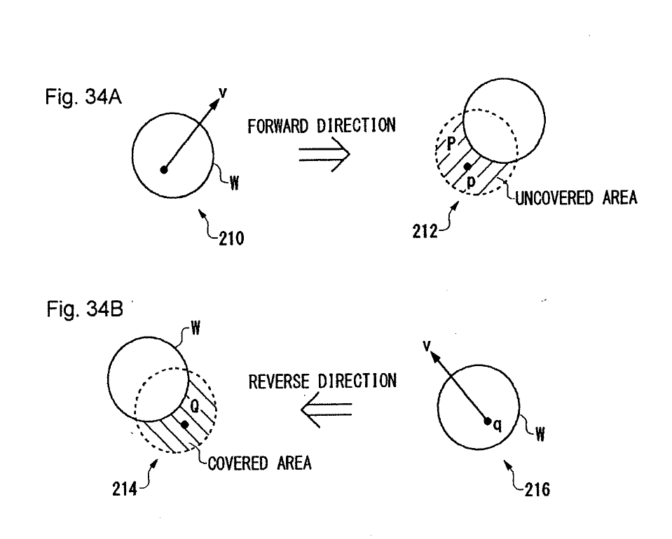

FIGS. 34A and 34B show a difference between a covered area and an uncovered area. An area denoted by “P” in FIG. 34A is behind an occluder W in a source image frame 210 but is observed in a destination image frame 212 as a result of the movement of the occluder. The motion vector of a point p included in the area P will be studied. In the forward direction, the size of the motion vector is 0 since the point p is not observed in the source image frame 210. In the reverse direction, the motion vector of the point p will have a certain size. Accordingly, it is determined that the point p, for which the size of the motion vector in the forward direction is 0 and the size of the motion vector in the reverse direction is v, is determined as being included in an uncovered area.

An area denoted by “Q” in FIG. 34B is observed in a source image frame 214 but is no longer observed in a destination image frame 216 as a result of being hidden behind an occluder W. The motion vector of a point q included in the area Q will be studied. In the reverse direction, the size of the motion vector is 0 since the point q is not observed in the destination image frame 216. In the reverse direction, the motion vector of the point p will have a certain size. Accordingly, it is determined that the point p, for which the size of the motion vector in the forward direction is v and the size of the motion vector in the reverse direction is 0, is determined as being included in an uncovered area.

Referring back to FIG. 33, the mask generator 158 generates a mask that retrieves only those pixels included in the covered area and the uncovered area detected in S244 (S246). The mask is delivered to the edge degree determining unit 136 as mentioned above and is used to retrieve a desired edge image.

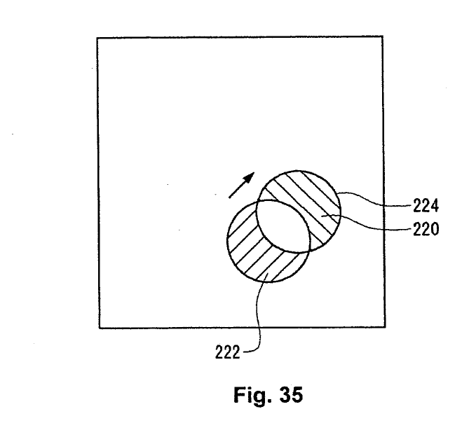

FIG. 35 shows an example of a mask. The shape of the mask represents a sum of sets of the covered area 220 and the uncovered area 222.

As described above, three highly precise maps related to image frames can be generated according to the embodiment. More specifically, the maps include: a segment map which differentiates an occluder moving between image frames from a background part; a motion-vector map in which precision is improved in the neighborhood of the boundary of the occluder; and an occlusion map showing a covered area and an uncovered area. These maps may be combined as appropriate for use in various image processes.

Generally, the base technology enables highly precise matching between a source image frame and a destination image frame. However, the base technology requires that the bijectivity condition be fulfilled between image frames in order to detect a mapping target. For this reason, if there is an occluder moving between image frames, the reliability of matching may be lower in a covered area hidden by an occluder or in an uncovered area in which a background presents itself from behind an occluder, than in the other parts. This is because a mapping target is not actually found in a counterpart image frame and so a true mapping target cannot be found. When matching precision is low, accuracy in motion vectors calculated on the basis of matching will also be low.

In this embodiment, a motion vector is obtained by using corresponding point information obtained according to the base technology. By using the motion vector thus obtained, a reliable area and a non-reliable area are roughly isolated from each other. In the non-reliable area, the motion vector obtained according to the base technology is not used, and a motion vector is estimated by using the surrounding motion vectors. A motion vector is ultimately obtained by block matching. By employing this approach, accuracy of motion vectors can be improved even in an occlusion area.

In the embodiment, segments are generated such that a seed block is defined in an image frame and a determination is made as to whether surrounding blocks can be included in the same segment. By generating segments in this way, an occlusion area and the other areas can be ultimately isolated from each other with high precision. By isolating an occlusion area in this way, predictive images for compression of moving images can be generated. More specifically, a predictive image for the areas other than an occlusion area is generated by using corresponding point information obtained according to the base technology. In an occlusion area, other matching methods (e.g., block matching) without the constraint of the bijectivity condition can be used to generate a predictive image. By using a plurality of matching methods for respective purposes, precision in motion prediction in compression decoding of moving images is improved in an occlusion area or in the neighborhood thereof as compared to the case where only the base technology is used. Therefore, moving picture compression producing decoded images with higher precision is achieved.

One of the features of the embodiment is that corresponding point information obtained according to the base technology is used both in the process of generating segments and in the process of improving a motion vector. These processes can be performed in parallel.

Described above is an explanation based on the exemplary embodiments of the present invention. These embodiments are intended to be illustrative only and it will be obvious to those skilled in the art that various modifications to constituting elements and processes could be developed and that such modifications are also within the scope of the present invention.

In the embodiment, segmentation by the segmenting unit 120, and motion vector improvement and mask generation by the motion vector processor 150, which are two individual processes that can be performed separately, are combined. Accordingly, each of the processes described can be replaced by a process using an algorithm other than the one shown in this specification.

What is claimed is:

1. An image processing method comprising:
computing matching so as to detect corresponding point information indicating pixel-by-pixel correspondence between in two image frames in image data comprising consecutive image frames;
calculating affine parameters indicating deformation of a block occurring between image frames, on the basis of the corresponding point information; and
segmenting an image frame into a plurality of groups of blocks characterized by movements approximating each other, by referring to the affine parameters to combine blocks.

2. The image processing method according to claim 1, wherein
whether to combine blocks is determined on the basis of an error between a representative pixel value of a source block and a representative pixel value of a block at a target of transformation using affine parameters.

3. The image processing method according to claim 1, further comprising:
generating an edge image that represents a boundary between a moving object and a still object in an image frame;
determining a seed block that serves as a starting point in combining blocks in an image frame;
comparing, in determining whether to combine blocks, a pixel value of an edge image included in the seed block and a pixel value of an edge image included in an adjacent block; and
combining the seed block and the adjacent block when a difference in the pixel values is equal to or smaller than a threshold.

4. An image processing apparatus comprising:
an image reader which receives a source image frame and a destination image frame in image data comprising consecutive image frames, and segmenting the frames into blocks;
a matching processor which computes matching to detect corresponding point information indicating correspondence between the source image frame and the destination image frame, and generating a corresponding point information file which describes coordinates of corresponding points in the image frames;
an affine parameter calculating unit which calculates affine parameters indicating deformation and movement of a block occurring between the source image frame and the destination image frame, on the basis of the corresponding point information;
a seed block selector which refers to the affine parameters so as to select, from the blocks within the source image frame, a seed block serving as a starting point for area growth; and
an expander which repeats a determination as to whether the seed block should be combined with a block adjacent to the seed block so as to segment an image frame into a group of background blocks characterized by movements approximating each other and the other groups of blocks.

5. The image processing method according to claim 4, wherein
the expander comprises an expansion determining unit which assigns the same affine parameters as the seed block to the adjacent block, and determines that the seed block and the adjacent block should be combined when a difference between a representative pixel value of the adjacent block at the destination of movement using the affine parameters and a representative pixel value of a corresponding block in the destination image frame is equal to or smaller than a predetermined threshold, and
the expander repeats the process of combining the seed block and adjacent blocks until there are no more adjacent blocks that can be combined.

6. The image processing method according to claim 4, wherein
the seed block selector examines the source image frame blocks subjected to affine transformation and selects, as a seed block, a block characterized by a minimum error between a representative pixel value of the block and a representative pixel value of a corresponding block in the destination image frame, and
the expander combines the adjacent block with the seed block, when a difference between a representative pixel value of a block identified by applying the affine parameters of the seed block to the adjacent block for transformation, and a representative pixel value of a block in the destination image frame which block corresponds to the adjacent block is equal to or smaller than a threshold.

7. The image processing method according to claim 4, wherein
the expander comprises an edge retrieving unit which generates an edge image by detecting an edge between an object and the background in an image frame, and detects an edge between a moving object and a still object by removing an edge between still objects by multiplying an occlusion area with the edge image, the occlusion area being hidden behind an object moving between image frames or presenting itself from behind the object, and
the expander determines whether to combine the seed block with the adjacent block on the basis of comparison between a pixel value of an edge included in the seed block and a pixel value of an edge included in the adjacent block.

8. A computer program product comprising:
a module which computes matching so as to detect corresponding point information indicating pixel-by-pixel correspondence between two image frames in image data comprising consecutive image frames;
a module which calculates affine parameters indicating deformation of a block occurring between image frames, on the basis of the corresponding point information; and
a module which segments an image frame into a plurality of groups of blocks characterized by movements approximating each other, by referring to the affine parameters to combine blocks.

9. An image processing method comprising:
computing matching between two image frames in image data comprising consecutive image frames so as to generate corresponding point information indicating correspondence between the image frames;
calculating a motion vector for each pixel, on the basis of a result of matching;
detecting, on the basis of the motion vector, an occlusion area, the occlusion area being an area where an object is hidden in a frame by another object in the same frame, or where an object hides another object in the same frame; and
isolating a stationary part from a moving part in an image frame, on the basis of the motion vector and the occlusion area.
